(19) United States
(12) Patent Application Publication
(10) Pub. No.: US 2025/0287402 A1
(43) Pub. Date: Sep. 11, 2025

(54) FBE CHANNEL ACCESS IN SIDELINK UNLICENSED

(71) Applicant: InterDigital Patent Holdings, Inc., Wilmington, DE (US)

(72) Inventors: Tuong Duc Hoang, Montreal (CA); Tao Deng, New York, NY (US); Aata El Hamss, Laval (CA); J.Patrick Tooher, Montreal (CA); Martino M. Freda, Laval (CA); Moon-il Lee, Melville, NY (US)

(73) Assignee: InterDigital Patent Holdings, Inc., Wilmington, DE (US)

(21) Appl. No.: 18/859,432

(22) PCT Filed: Apr. 26, 2023
(86) PCT No.: PCT/US2023/019900

§ 371 Date: Oct. 23, 2024

Related U.S. Application Data
(60) Provisional application No. 63/334,829, filed on Apr. 26, 2022.
(60) Provisional application No. 63/395,970, filed on Aug. 8, 2022.
(60) Provisional application No. 63/421,789, filed on Nov. 2, 2022.
(60) Provisional application No. 63/445,411, filed on Feb. 14, 2023.

(51) Int. Cl. H04W 72/25; H04L 5/00; H04W 76/18

(52) U.S. Cl. CPC H04W 72/25; H04L 5/0055; H04W 76/18

(57) ABSTRACT

Systems, methods, and instrumentalities are described herein that may be associated with frame-based equipment (FBE) channel access in sidelink (SL) unlicensed. A wireless transmit/receive unit (WTRU) may receive configuration information that indicates a channel busy ratio (CBR) threshold. The WTRU may determine a CBR value associated with a channel in a listen before talk (LBT) band. The WTRU may compare the CBR value to the CBR threshold. The WTRU may determine a channel access parameter based on the comparison of the CBR value to the CBR threshold. The WTRU may change the channel access parameter.

### CROSS-REFERENCE TO RELATED APPLICATIONS

This application claims the benefit of U.S. Provisional Patent Application No. 63/334,829, filed Apr. 26, 2022, U.S. Provisional Patent Application No. 63/395,970, filed Aug. 8, 2022, U.S. Provisional Patent Application No. 63/421,789, filed Nov. 2, 2022, and U.S. Provisional Patent Application No. 63/445,411, filed Feb. 14, 2023, the disclosures of which are incorporated herein by reference in their entirety.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein that may be associated with frame-based equipment (FBE) channel access in sidelink (SL) unlicensed.

A device (e.g., a wireless transmit/receive unit (WTRU)) may receive configuration information that indicates a channel busy ratio (CBR) threshold. The device may determine a CBR value associated with a channel in a listen before talk (LBT) band. The device may compare the CBR value to the CBR threshold. The device may determine a channel access parameter based on the comparison of the CBR value to the CBR threshold. The device may change the channel access parameter.

The configuration information may indicate a channel access failure threshold and a fixed frame period (FFP) switching window. The device may (e.g., prior to comparing the CBR value to the CBR threshold) perform a number of channel access attempts associated with the FFP switching window. The device may (e.g., prior to comparing the CBR value to the CBR threshold) determine that the number of channel access attempts satisfies the channel access failure threshold.

Comparing the CBR value to the CBR threshold may involve comparing the CBR value to the CBR threshold based on a number of channel access attempts satisfying the channel access failure threshold. Changing the channel access parameter may involve changing an FFP configuration if the CBR value is less than the CBR threshold. The FFP configuration may include one or more of: an FFP periodicity or an FFP offset value. Changing the channel access parameter may involve switching to a different LBT band or sub-band if the CBR value satisfies the CBR threshold. Changing the channel access parameter may involve changing a resource block set if the CBR value satisfies the CBR threshold.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example FFP configuration in an FBE frame for an FBE system.

FIG. 3 illustrates an example of a WTRU selecting different FFP offsets based on whether the WTRU has a HARQ enabled sidelink service.

FIG. 4 illustrates an example of a WTRU persistently failing a clear channel assessment (CCA) based on one or more WTRUs in a system.

FIG. 5 illustrates an example associated with a WTRU flexibly updating one or more access parameters.

FIG. 6 illustrates an example of HARQ feedback options for a transmission requiring HARQ feedback.

FIG. 7 illustrates an example of an implicit mapping rule between PSCCH/PSSCH and a PSFCH resource.

FIG. 8 shows an example of a WTRU determining the set of resource elements REs/PRBs to feedback the associated PSCCH/PSSCH.

FIG. 9 illustrates an example of a WTRU determination whether to puncture/rate-match a (e.g., one) PSCCH/PSSCH.

FIG. 10 illustrates an example of a (pre)configured resource for an S-SSB transmission.

FIG. 11 illustrates an example of a WTRU pausing a transmission for an S-SSB and resuming the transmission afterward.

FIG. 12 shows an example of a WTRU determining which S-SSB pattern(s) to transmit.

FIG. 13 illustrates an example of a configuration with multiple types of S-SSB resources.

FIG. 14 illustrates an example of a configuration of multiple types of S-SSB resource(s) for an S-SSB burst case.

FIG. 15 illustrates an example of a configuration (e.g., for a WTRU) for a burst of S-SSB occasions per synchronization period.

FIG. 16 illustrates an example of a WTRU using the COT obtained for data transmission to transmit an S-SSB.

FIG. 17 illustrates a WTRU sharing its COT/FFP with another WTRU.

### DETAILED DESCRIPTION

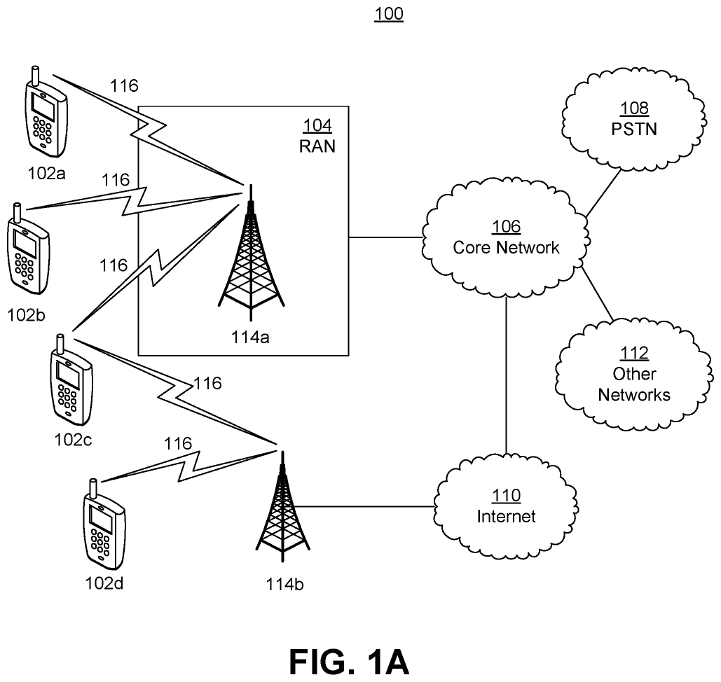

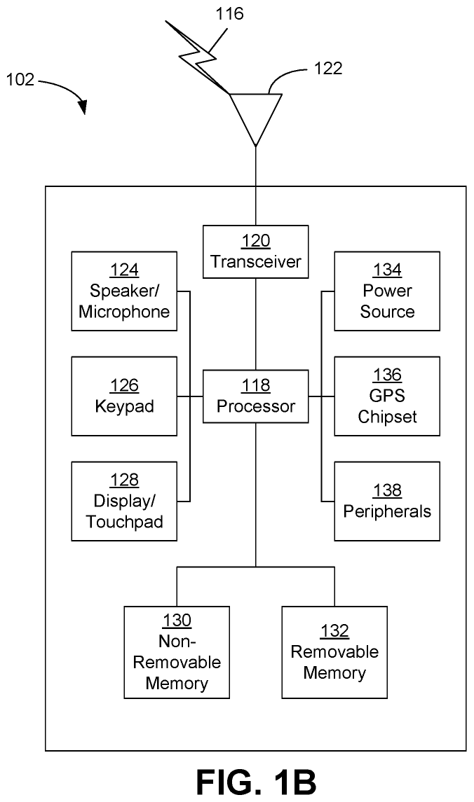

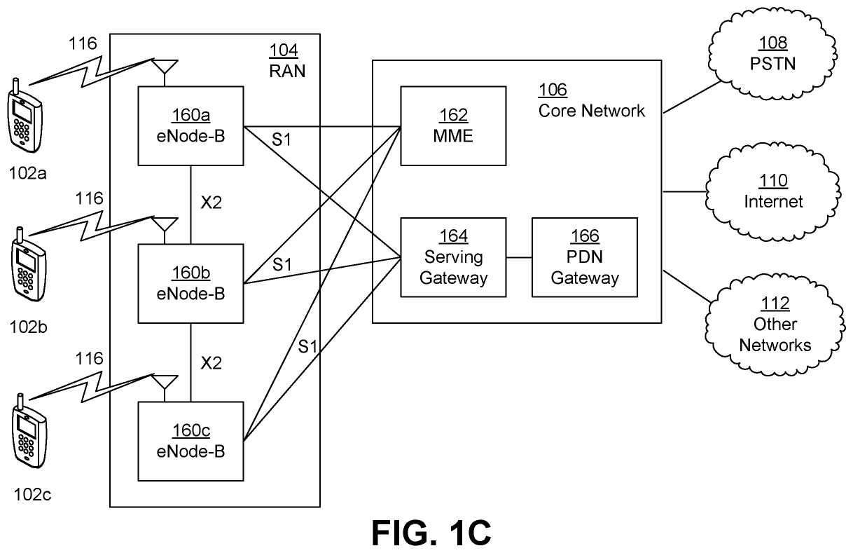

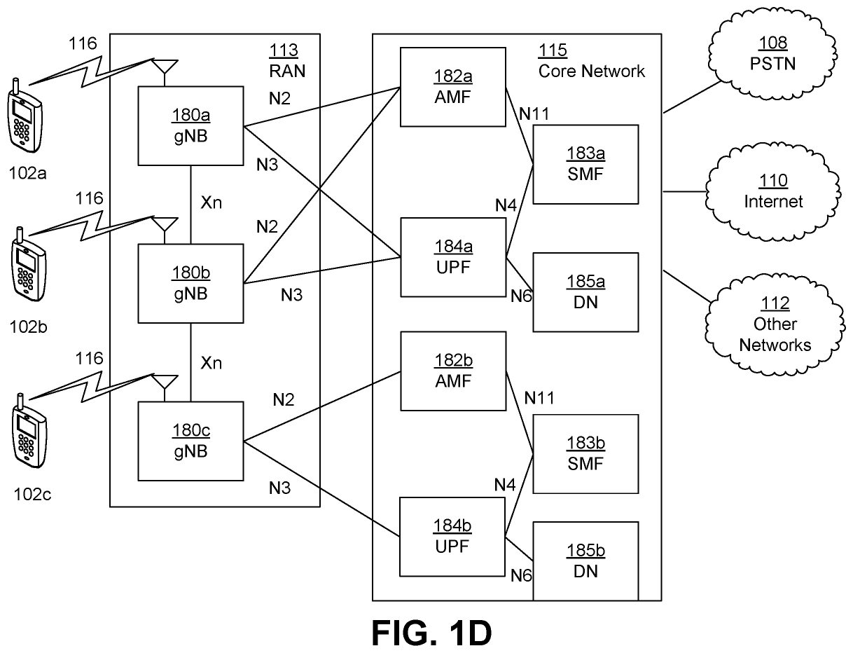

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as machine type communication (MTC) devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different packet data unit (PDU) sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Feature(s) associated with resource prioritization are provided herein. Feature(s) associated with resource allocation are provided herein. Feature(s) associated with a synchronization procedure are provided herein.

A WTRU may determine whether to reserve a channel occupancy time (COT) period/fixed frame period (FFP). A WTRU may determine the cyclic prefix extension (CPE) of a transmission based on reservation information in a reserved resource. A WTRU may change its FFP configuration based on the resource reservation information. A WTRU may rate-match/puncture a PSCCH/PSSCH before a reserved COT/FFP of another WTRU. A WTRU may determine whether to allow other WTRU(s) to share its COT/FFP. A WTRU may reselect frequency resources (e.g., interlace) for a PSCCH/PSSCH transmission in its FFP. A WTRU may determine whether to preempt its COT/FFP.

Systems, methods, and instrumentalities are described herein for frame-based equipment (FBE) channel access in sidelink (SL) unlicensed.

A wireless transmit/receive unit (WTRU) may select fixed frame (FF) parameters. For example, a WTRU may determine a fixed frame period (FFP) configuration for a (e.g., one) channel access type. The WTRU may inform another node of the WTRU's FFP configuration. The WTRU may trigger sending an FFP configuration to another node. The WTRU may (e.g., determine to) change an FFP configuration for a (e.g., one) channel access type.

A WTRU may provide sidelink feedback. The WTRU may request hybrid automatic repeat request (HARQ) feedback for a (e.g., one) transmission of a transport block (TB). The WTRU may determine a physical sidelink feedback channel (PSFCH) occasion and/or PSFCH resource. For example, a transmitting WTRU (Tx WTRU) may indicate the maximum number of HARQ feedback attempts. The WTRU may perform a retransmission for a TB based on, for example, the HARQ feedback status. The WTRU may determine when to terminate a HARQ feedback attempt for a (e.g., one) transmission. The WTRU may determine channel occupancy times (COTs) and/or FFPs in which to perform HARQ feedback for a (e.g., one) transmission. The Tx WTRU may indicate information about a HARQ feedback of a transmission. For example, a receiving WTRU (Rx WTRU) may perform a HARQ feedback to the Tx WTRU(s). The Tx WTRU may indicate the maximum number of HARQ feedback attempts. The WTRU may determine a HARQ feedback occasion in which to perform HARQ feedback of a (e.g., one) transmission. The WTRU may request a HARQ feedback in the WTRU's current COT and/or FFP. The WTRU may determine a transmission type for a TB. The WTRU may determine whether to puncture/rate-match a physical sidelink control channel (PSCCH)/physical sidelink shared channel (PSSCH) in a PSFCH slot.

A WTRU may implement a synchronization procedure. For example, a WTRU may transmit a synchronization signal block (SSB) in a (pre)configured resource. The WTRU may determine whether to perform a clear channel assessment (CCA) and/or listen-before-talk (LBT), for example, before a (pre)configured resource for sidelink SSB (S-SSB) transmission. The WTRU may determine the number of S-SSB transmissions in a synchronization period. The WTRU may pause the WTRU's COT and/or FFP for another transmission. The WTRU may resume the WTRU's COT and/or FFP after a (pre)configured resource.

A WTRU may perform resource allocation. For example, the WTRU may determine whether to initialize a COT and/or FFP (e.g., a new COT and/or FFP). The WTRU may determine whether to share a COT and/or FFP with another WTRU. The WTRU may determine the number of interlaces to select. The WTRU may perform resource reservation.

A WTRU may determine to perform a different load-based equipment (LBE) channel access type. The WTRU may perform FBE and/or LBE to access the channel. The WTRU may determine the set of resource elements (REs) and/or physical resource blocks (PRBs) to transmit HARQ feedback. The WTRU may resume its COT/FFP after a physical SL feedback channel (PSFCH) resource. The WTRU may be (pre)configured with a mapping of a physical SL control channel (PSCCH) and/or physical SL shared channel (PSSCH) to multiple PSFCH occasions. The WTRU may resume its COT/FFP after a (pre)configured resource. The WTRU may be (pre)configured with multiple types of resources for S-SSB transmission/reception. The WTRU may perform S-SSB transmission in the (pre)configured S-SSB slot in a resource pool. The WTRU may be (pre)configured with types of S-SSB transmission. The WTRU may determine which S-SSB option and/or S-SSB pattern to transmit.

In a HARQ-enabled TB, a Tx WTRU may request that a receiving WTRU (Rx WTRU) provide feedback in the Tx WTRU's COT and/or FFP (e.g., the Tx WTRU may indicate the PSFCH occasion to provide feedback) and/or provide feedback in the Rx WTRU's (e.g., the Rx WTRU's own) initiated COT and/or FFP. The Tx WTRU may determine whether to request the feedback in the Tx WTRU's COT/FFP or in the Rx WTRU's COT/FFP based on one or more of the following: a quality of service (QOS) of the TB, the remaining transmissions of the WTRU in the period (e.g., to maintain the COT until the indicated PSFCH), the remaining COT duration, and/or the gap to the next COT and/or FFP of the Rx WTRU(s).

A WTRU (e.g., Tx WTRU) may perform one or more (e.g., any combination) of the following for transmission of a HARQ-enabled TB: receive a PSFCH configuration in the resource pool (e.g., every slot); receive a COT and/or FFP and PSFCH configuration from a peer WTRU (e.g., WTRU-B), for example, via PC5-RRC; acquire a COT in an (e.g., one) FFP; determine (e.g., for a/each transmission of a TB with HARQ enabled) the feedback occasion based on one or more of the priority of the TB, the remaining number of the transmission, the remaining COT duration, the gap to the next COT and/or FFP of the Rx WTRU(s), and/or PSFCH configuration; determine the duration and/or the number of HARQ feedback attempts for the Rx WTRU (e.g., based on the QoS of the TB and/or the FFP configuration of the WTRU); indicate the HARQ feedback occasion(s)/resource(s) in the SL control information (SCI) for a (e.g., each) transmission and/or the maximum number of feedback attempts; monitor the feedback for a (e.g., each) transmission; and/or access the channel and perform retransmission for the TB (e.g., if a NACK/DTX is detected in the maximum number of HARQ attempts).

An Rx WTRU may perform channel access (e.g., contiguously) in a COT and/or FFP (e.g., each FFP period) until successfully transmitting a (e.g., one) PSFCH out of N occasions. For example, the Rx WTRU may perform channel access in a COT and/or FFP until successfully transmitting a PSFCH out of N occasions based on receiving a transmission from a Tx WTRU involving (e.g., requiring) feedback in the Rx WTRU's FFP in a PSFCH occasion (e.g., one PSFCH occasion) of N PSFCH occasions.

A WTRU (e.g., Rx WTRU) may execute one or more (e.g., any combination) of the following procedures (e.g., to perform HARQ feedback transmission for one or more transmissions): determine an FFP configuration (e.g., period and/or offset), for example, based on whether the configured service supports HARQ feedback (e.g., the initial symbols of COT and/or FFP may be used for PSFCH transmission, for example, if the service supports HARQ feedback, and for PSCCH/PSSCH, for example, if the service does not support HARQ feedback); receive a transmission of the Tx WTRU (e.g., which may indicate at least one of the following: performing HARQ feedback in the Rx WTRU's COT and/or FFP, and/or assessing maximum N clear channel assessment (CCA) occasions); perform CCA (e.g., for each COT and/or FFP in the next N COTs and/or FFPs) to access the channel and transmit PSFCH in the PSFCH occasion until it successfully transmits PSFCH on an (e.g., one) occasion; and/or report a channel access failure to a gNB, for example, if the WTRU fails to access the channel in (e.g., all) N occasions.

Sidelink (SL) operation may be implemented in unlicensed spectrum. Sidelink operation may be implemented for Mode 1 and Mode 2 in unlicensed spectrum in FR1 (e.g., SL U). Unlicensed SL frequency bands may be, for example, 5 GHZ and 6 GHZ. The Uu operation related to Mode 1 may be (e.g., limited to only) licensed spectrum. The SL U channel access may be based on regional regulations. The NR U channel access may be a starting point.

An SL resource allocation mechanism for licensed spectrum may be re-used for SL operation in the UL spectrum. SL U may implement changes to NR SL physical (PHY) channel structures and procedures to operate in unlicensed spectrum (e.g., HARQ feedback supported in NR V2X for unicast and groupcast transmissions).

NR U channel access may be provided for a frame-based equipment (FBE) system. The FBE system may be utilized in environments where the absence of other technologies is guaranteed (e.g., by government regulations, private premises policies, etc.).

A WTRU (e.g., in an NR U FBE system) may be configured with a fixed frame period (FFP) for channel access, which may include the offset and FFP. The WTRU may perform a burst transmission from the beginning of FFP until T_{idle} (e.g., where T_{idle}=max {5% of FFP, 100 us}). Data may be transmitted if the channel is clear. A WTRU may perform a CCA (e.g., for 9 or 16 us, which may be based on a local regulation). A WTRU may (e.g., otherwise) wait until a next cycle for CCA.

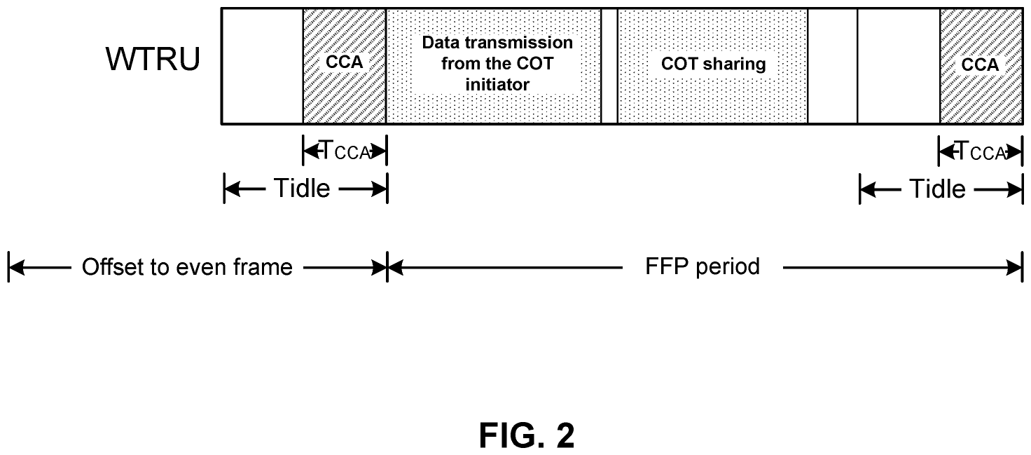

FIG. 2 illustrates an example FFP configuration in an FBE frame for an FBE system.

A WTRU may be configured with FFP, for example, from a system information block (SIB) and/or a dedicated RRC with a different offset and/or FFP. An FFP may be asynchronous to the gNB. An FFP may be configurable (e.g., may be {1, 2, 2.5, 4, 5, 10} ms). A WTRU may change an FFP configuration (e.g., after 200 ms).

A gNB may share a COT initiated by a WTRU (e.g., WTRU COT initiator), for example, in a downlink (DL) transmission (e.g., if the WTRU is one of the target receivers). A WTRU may share a COT initiated by the gNB (e.g., gNB COT initiator). Multiple (e.g., two) WTRUs may not share a COT (e.g., based on gNB enforcement of a restriction).

A gNB (e.g., in NR U) may perform UL scheduling. A gNB may configure FFP and/or schedule UL resources for data and/or feedback for a (e.g., each) WTRU, for example, to avoid (e.g., guarantee against) collisions among UL transmissions.

A WTRU (e.g., in Mode 2 FBE) may (e.g., autonomously) select an FFP configuration and/or may perform resource allocation for transmission of PSFCH and/or data. Coordination may be provided between a Tx WTRU and an Rx WTRU for HARQ enabled transmission (e.g., with respect to the uncertainty of channel access).

A statement that a WTRU may be (pre)configured (e.g., with something) may be equivalent to, and may be used interchangeably with, a statement that “the WTRU is preconfigured (e.g., with something)” or the statement that “the WTRU may receive a configuration” (e.g., of something), for example, from another node (e.g., gNB).

Preemption and/or resource re-evaluation may be used to determine whether a preselected resource (e.g., for resource re-evaluation) or a reserved resource (e.g., for preemption) may still be available for transmission. If the resource is still available, the WTRU may use the resource for transmission. If the resource is not available, the WTRU may select another resource for transmission. Resource allocation may be used to determine the resource for transmission. Therefore, resource allocation, preemption, and resource re-evaluation may be used interchangeably. These terms may describe, for example, identifying whether a preselected or reserved resource is still available and/or identifying the available resources for transmission based on sensing and extracting the sensing result. Resource allocation may refer to an initial resource allocation, preemption, and/or resource re-evaluation.

FFP parameters may be selected. A WTRU may (e.g., determine to) perform a different FBE channel access type. In some examples, a WTRU may perform one or more FBE channel access types. A (e.g., each) channel access type may be associated with a (e.g., one) FFP configuration. An (e.g., each) FFP configuration may include, for example, one or more (e.g., any combination) of the following parameters: a COT and/or FFP; an FFP offset; a CCA duration, which may include a zero CCA duration (e.g., no CCA); an idle period, which may include a zero idle period (e.g., no idle period); a frequency of channel access per one or more COTs and/or FFPs; one or more listen-before-talk (LBT) parameters to access the channel; a PSFCH configuration with a COT and/or FFP, which may include, for example, one or more (e.g., any combination) of following: the availability of PSFCH in the COT and/or FFP, the periodicity of PSFCH, the number of PSFCH occasions within the COT and/or FFP, the existence of PSFCH at the beginning, middle, and/or the end of the COT, the number of PSFCH resources within one PSFCH occasion, and/or the mapping rule between PSCCH/PSSCH and PSFCH in the COT and/or FFP.

The term FFP may be used interchangeably with the term COT as used herein. For example, FFP and/or COT may be used to indicate the channel occupancy time or the channel occupancy period of the WTRU. Clear channel assessment (CCA) and/or LBT duration may include one or more of the following: no CCA/LBT (e.g., the WTRU may perform transmission without LBT/CCA); fixed CCA/LBT (e.g., the WTRU may perform CCA/LBT for a fixed duration of, for example, 9 us/16 us/25 us, which may be similar to type 2A and/or type 2B LBT); or flexible CCA/LBT duration (e.g., the WTRU may perform type 1 LBT before transmission of one or more TBs).

The terms CCA may be used interchangeably herein with the term LBT. The terms may be used to describe the procedure in which the WTRU senses the channel before transmission.

The WTRU may (e.g., determine to) perform different load-based equipment (LBE) channel access types. The WTRU may perform one or more LBE channel access types. A channel access type (e.g., each channel access type) may be associated with one or more LBT parameters. The WTRU may determine one or more of the following LBT parameters: LBT type for a LBT sub-band channel access (e.g., LBT type 1, 2, 2A, 2B, and/or 2C); the channel access priority class (CAPC); contention window size, which may include the current contention window (e.g., CWₚ), the minimum and/or the maximum contention window associated with the channel access priority class p (e.g., CWₚ, CW_{min,p}, and CW_{max,p}); the current value or the initial value of the backoff counter (N); the COT duration, which may include the current COT and/or the maximum COT; the defer period (e.g., T_{d}); the LBT energy detection threshold used to determine the availability of a channel; the FFP configuration; the CCA duration; or the channel access time in slots (e.g., each slot) or the cyclic prefix extension (CPE) duration. In examples, the WTRU may be (pre)configured with an earlier (e.g., sooner) channel access time and/or a longer CPE duration for one type of transmission (e.g., a high priority transmission such high priority data, S-SSB). In examples, the WTRU may be (pre)configured with a later channel access time and/or a smaller CPE duration for another type of transmission (e.g., a low priority transmission such as low priority data).

LBT parameters may include one or more of the parameters related to the channel access procedure. The parameters may include the LBT type for an LBT sub-band channel access, CAPC, contention window size, which may include CWₚ, CW_{min,p}, and CW_{max,p}, the current or initialized backoff counter N, the COT duration, the defer period, the LBT energy detection, the FFP configuration, and/or the CCA duration.

In an example of performing an FBE channel access based on an FFP offset, a WTRU may be (pre)configured with multiple (e.g., two) type of FFP offsets. A first type of FFP offset may be associated with a slot level FFP offset. A second type of FFP offset may be associated with a symbol level FFP offset.

In an example of performing an FBE channel access based on a frequency of channel access per one or more COTs and/or FFPs, a WTRU may be allowed (e.g., in an FFP configuration) to access the channel (e.g., at most) X % of the time (e.g., in each observation period). For example, the WTRU may be allowed to access the channel in X COTs and/or FFPs out of total N COTs and/or FFPs. A WTRU may be allowed (e.g., in an FFP configuration) to access the channel (e.g., at most) X consecutive COTs and/or FFPs. In an (e.g., additional and/or alternative) example, a WTRU may be allowed to access the channel (e.g., at most) X (ms) in a set of (e.g., consecutive) COTs and/or FFPs.

In an example of performing an FBE channel access based on a PSFCH configuration with a COT and/or FFP, a WTRU may not have PSFCH within the COT and/or FFP (e.g., based on an FFP configuration). A WTRU may have PSFCH every N slots (e.g., based on an FFP configuration). A WTRU may have PSFCH at one or more slots in the middle of the COT of the WTRU (e.g., based on an FFP configuration). A WTRU may have a PSFCH (e.g., only) at the end of the COT of the WTRU (e.g., based on an FFP configuration). A WTRU may have a PSFCH at the beginning of the COT and/or FFP (e.g., based on an FFP configuration). A WTRU may have a PSFCH at the beginning of the COT and/or FFP and at the end of the COT (e.g., based on an FFP configuration).

A WTRU may determine which FBE channel access type to perform, for example, based on one or more the type of channel the WTRU may transmit (e.g., PSFCH, PSCCH/PSSCH, and/or S-SSB). For example, the WTRU may use the first FFP configuration to access the channel for PSCCH/PSSCH. The WTRU may use the second FFP configuration (e.g., no CCA) for PSFCH and/or S-SSB transmission.

The WTRU may perform FBE and/or LBE to access the channel. The WTRU may perform FBE-type channel access and/or LBE-type channel access to access the channel to perform transmission of one or more TB(s). For example, in one period, the WTRU may use FBE-based channel access to access the channel, in which the WTRU may perform CCA for a period (e.g., of 9 μs or 16 μs) and perform transmission within a (pre)configured duration. In another period, the WTRU may use LBE-based channel access to access the channel, in which the WTRU may perform LBT (e.g., type 1 LBT). In another period, the WTRU may use LBE-based channel access to access the channel, in which the WTRU may perform another type of LBT (e.g., type 2 LBT).

A WTRU may determine an FFP configuration for a (e.g., one) channel access type. A WTRU may determine one or more (e.g., any combination) of the following parameters for a (e.g., one) channel access type: a COT and/or FFP; an FFP offset; a CCA duration, which may include a zero CCA/LBT duration (e.g., no CCA/LBT, fixed CCA/LBT duration such as 9 μs, 16 μs, or 25 μs and/or flexible CCA/LBT duration); an idle period, which may include a zero idle period (e.g., no idle period); a frequency of channel access per one or more COTs and/or FFPs; and/or a PSFCH configuration with the COT and/or FFP.

The value of one or more parameters of an FFP configuration may be determined based on one or more (e.g., any combination) of the following: the destination ID(s) of the services; a QoS (e.g., established logical channels (LCHs)/sidelink radio bearers (SLRBs) of a sidelink service) associated with a sidelink communication service; a traffic pattern; and/or a HARQ feedback requirement of the established sidelink service.

In an example of determining the value of one or more parameters of an FFP configuration based on the destination ID(s) of the services, a WTRU may be (pre)configured with a (e.g., one) FFP configuration for a (e.g., one) sidelink service. The WTRU may be involved in (e.g., engaged with) multiple sidelink services. The WTRU may determine the FFP configuration for multiple sidelink services, for example, based on the FFP configuration for each sidelink service. For example, the WTRU may select the smallest COTs and/or FFPs or the highest common divisor of all COTs and/or FFPs (pre)configured for each side link service.

In an example of determining the value of one or more parameters of an FFP configuration based on QoS (e.g., established LCHs/SLRBs of a sidelink service) associated with a sidelink communication service, a WTRU may establish a sidelink communication service. The WTRU may be (pre)configured with one or multiple LCHs/SLRBs. The WTRU may determine the QoS parameters associated with the sidelink communication service, such as latency requirement, priority, etc. The WTRU may determine an FFP configuration, for example, based on the associated QoS parameters. The WTRU may determine an FFP configuration, for example, based on the established LCHs/SLRBs for the sidelink communication.

In an example of determining the value of one or more parameters of an FFP configuration based on a traffic pattern, a WTRU may select an FFP offset and/or COT and/or FFP as a function of the sidelink traffic pattern. A WTRU may select a COT and/or FFP to be equal to the traffic generation period of the WTRU. The WTRU may select the FFP offset to be equal to the traffic generation offset of the WTRU.

In an example of determining the value of one or more parameters of an FFP configuration based on a HARQ feedback requirement of an established sidelink service, a WTRU may determine an FFP configuration based on the availability of the sidelink communication service requiring/allowing HARQ feedback at the beginning of the COT and/or FFP of the Rx WTRU. In an example, a WTRU may have a sidelink service that requires HARQ feedback. The WTRU may select an FFP offset having symbol level granularity. The WTRU may select an FFP offset, for example, to enable the WTRU to transmit PSFCH at the beginning of the COT and/or FFP. The WTRU may select an FFP offset having slot level granularity, for example, if the WTRU does not have a sidelink service requiring HARQ feedback. The WTRU may select the FFP offset such that the WTRU is able to transmit PSCCH/PSSCH at the beginning of the COT and/or FFP. The WTRU may perform transmission in a PSFCH occasion (e.g., the PSFCH at the beginning of the COT and/or FFP) if the WTRU does not have HARQ feedback to transmit. The COT may be maintained. The WTRU may transmit one or any combination of the following: dummy data; a repetition of one or more symbols in the next PSCCH/PSSCH slot; and/or a sequence for automatic gain control (AGC) settling.

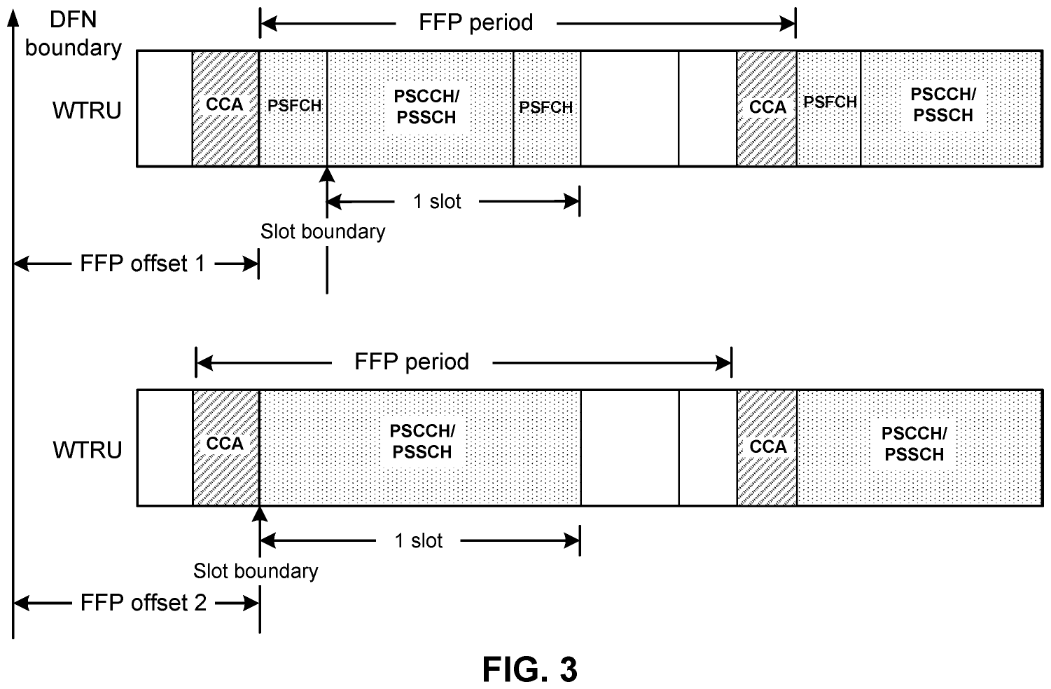

FIG. 3 illustrates an example of a WTRU selecting different FFP offsets based on whether the WTRU has a HARQ-enabled sidelink service. As shown by example in FIG. 3, a WTRU may choose the first FFP offset (e.g., FFP offset 1) for the first FFP configuration, for example, if the WTRU has a HARQ-enabled sidelink service. The WTRU may choose the second FFP offset (e.g., FFP offset 2) for the second FFP configuration, for example, if the WTRU does not have a sidelink service with HARQ-enabled transmission.

A WTRU may inform another node about the WTRU's FFP configuration. The WTRU may (e.g., determine to) transmit an FFP configuration of a (e.g., one) channel access type (e.g., one or more parameters of an FFP configuration) to another node (e.g., gNB, another WTRU). For example, a WTRU may report an FFP configuration to the network (e.g., to a gNB). The WTRU may use, for example, a UL medium access control (MAC) control element (CE), radio resource control (RRC), and/or a non-access stratum (NAS) message to report an FFP configuration to the network (e.g., to a gNB). For example, a WTRU may transmit an FFP configuration to another WTRU (e.g., with which the WTRU may have an ongoing unicast communication). For example, the WTRU may transmit an FFP configuration to a group of WTRUs (e.g., with which the WTRU may have an ongoing groupcast communication). The WTRU may use SCI (e.g., a second (2^{nd}) SCI), MAC CE, PC5 RRC, and/or NAS message to convey an FFP configuration to another node via a PC5 interface.

A WTRU may trigger sending an FFP configuration to another node. The WTRU may trigger sending the WTRU's FFP configuration of a (e.g., one) channel access type to another node (e.g., gNB, another WTRU) based on one or more (e.g., any combination) of the events described herein and/or based on one or more (e.g., any combination) of the following events: the WTRU establishes a unicast link with another WTRU; a groupcast service is established for a group of WTRUs; and/or the WTRU changes its FFP configuration.

In an example of triggering the sending a WTRU's FFP configuration of a (e.g., one) channel access type to another node based on the WTRU establishing a unicast link with another WTRU, the WTRU may send the FFP configuration to a peer WTRU (e.g., after a unicast link between two WTRUs is established). The WTRU may use PC5-RRC to inform the peer WTRU of the FFP configuration.

In an example of triggering the sending a WTRU's FFP configuration of a (e.g., one) channel access type to another node based on a groupcast service being established for a group of WTRUs, the WTRU may send the FFP configuration to the group of WTRUs based on (e.g., upon) establishing a groupcast connection. The WTRU may use a group PC5 RRC to convey the FFP configuration.

In an example of triggering the sending a WTRU's FFP configuration of a (e.g., one) channel access type to another node based on the WTRU changing the FFP configuration, the WTRU may trigger sending the FFP configuration to another node (e.g., to a peer WTRU in a/each unicast link, a group of WTRUs in a groupcast service, a gNB, etc.) if the WTRU changes one or more parameters of the FFP configuration (e.g., a change to FFP offset, COT and/or FFP, PSFCH configuration, etc.).

A WTRU may (e.g., determine to) change an FFP configuration for a (e.g., one) channel access type. A WTRU may (e.g., determine to) change the FFP configuration for a (e.g., one) channel access type by changing one or more (e.g., any combination) of the following parameters: the COT and/or FFP; the FFP offset; the CCA/LBT duration, which may include a zero CCA/LBT (e.g., no CCA/LBT, fixed CCA/LBT duration such as 9 μs, 16 μs, or 25 μs and/or flexible CCA/LBT duration); the idle period, which may include a zero idle period (e.g., no idle period); the frequency of channel access per one or more COTs and/or FFPs; and/or the PSFCH configuration with the COT and/or FFP.

The WTRU may (e.g., determine to) change one or more parameters in an FFP configuration based on, for example, one or more (e.g., any combination of) events described herein and/or one or more (e.g., any combination of) the following triggering events: receiving an indication from another node; detecting a semi-persistent CCA/LBT failure; and/or detecting a semi-persistent reservation from another WTRU.

In an example of changing one or more parameters in an FFP configuration based on receiving an indication from another node, a WTRU may receive an indication/request from another node (e.g., a WTRU) to change the WTRU's FFP configuration. The WTRU may (e.g., then) change the FFP configuration.

In an example of changing one or more parameters in an FFP configuration (e.g., FFP periodicity and/or an FFP offset value) based on detecting a semi-persistent CCA failure, the WTRU may (e.g., determine to) change the WTRU's FFP configuration (e.g., FFP offset, COT, and/or FFP) if the WTRU fails to access the channel N times in an observation period(s). For example, the WTRU may receive configuration information that indicates a channel access failure threshold (e.g., N). The WTRU may perform a number of channel access attempts (e.g., in an FFP switching window). The WTRU may determine that the number of channel access attempts satisfies the channel access failure threshold (e.g., the WTRU has failed to access the channel N times). The value of N may be determined, for example, based on the COT and/or FFP of the WTRU. The value of N may be (pre)configured.

The WTRU may fail to access the channel N times in an observation period(s). The WTRU may (e.g., determine to) change the FFP configuration and/or change the LBT band/sub-band (e.g., based on the failure). The WTRU may determine whether to change the FFP configuration and/or change the LBT band/sub-band, for example, based on the channel busy ratio (CBR) of the resource pool. The WTRU may determine (e.g., measure) a CBR value associated with the resource pool and/or LBT band. The WTRU may compare the CBR value to the CBR threshold. The WTRU may compare the CBR value to the CBR threshold based on the number of channel access attempts satisfying the channel access failure threshold (e.g., the WTRU failing to access the channel N times). The WTRU may (e.g., determine to) change a channel access parameter based on the comparison of the CBR value to the CBR threshold. For example, the WTRU may (e.g., determine to) change the FFP configuration if the CBR of the resource pool is smaller than (e.g., less than) a threshold (e.g., the CBR threshold). The WTRU may (e.g., determine to) switch to a different LBT band/sub-band, for example, if the CBR of the resource pool is larger than a (e.g., the same) threshold (e.g., if the CBR value satisfies the CBR threshold). The CBR threshold may be (pre)configured (e.g., the WTRU may receive configuration information that indicates the CBR threshold). The WTRU may change the channel access parameter (e.g., based on the determination). The WTRU may report to another node (e.g., to a gNB) if the WTRU fails to access the channel N times in an observation period, where N times may be (pre)configured to be consecutive or non-consecutive.

In an example of changing one or more parameters in an FFP configuration based on detecting a semi-persistent reservation from another WTRU, the WTRU may detect a semi-persistent reservation from another WTRU, which may cause at least N CCA failures in a (e.g., one) observation period for the WTRU.

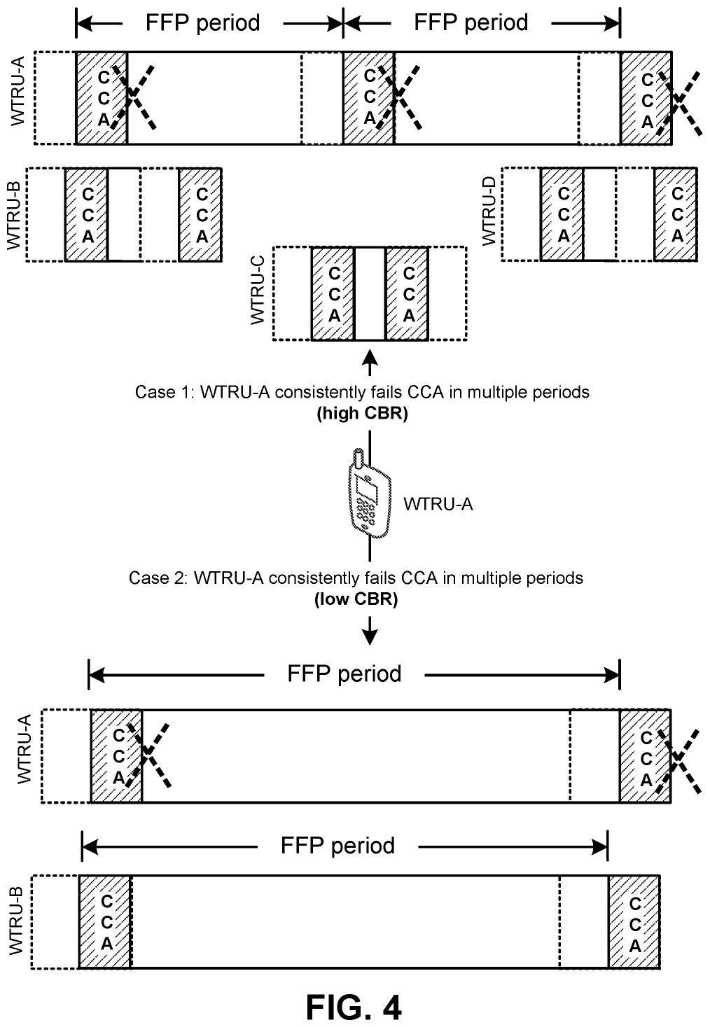

FIG. 4 illustrates an example of a WTRU persistently failing CCA, e.g., based on one or more WTRUs in a system. As illustrated in in FIG. 4, A WTRU may experience semi-persistent CCA failure in multiple FFPs. The WTRU (e.g., WTRU-A) may (e.g., in Case 1) experience CCA failure due to collision(s) with multiple WTRUs (e.g., WTRU-B, WTRU-C, WTRU-D) and due to high system load (e.g., one example that may result in high CBR). WTRU-A may (e.g., in Case 2) experience CCA failure due to another WTRU (e.g., WTRU-B) that has a same FFP and a CCA slot that is earlier than the CCA slot of the WTRU-A (e.g., one example that may result in low CBR). WTRU-A may determine to switch to different resource block (RB) sets/LBT sub-band for case 1. For example, WTRU-A may change to a resource block set/LBT sub-band if the CBR value satisfies the CBR threshold. WTRU-A may determine to change its FFP configuration for case 2.

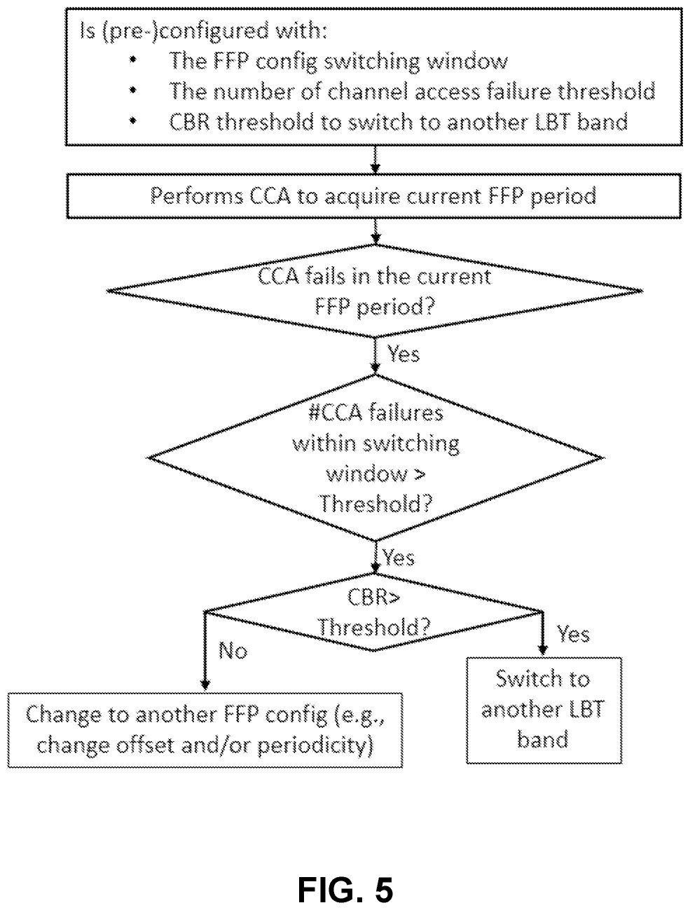

FIG. 5 illustrates an example where a WTRU may perform one or more actions to update (e.g., flexibly update) one or more access parameters. For example, the WTRU may be (pre)configured with one of more of the following: a switching window (e.g., an FFP configuration switching window), which may be used for the WTRU to evaluate its channel access failure status; a threshold number of channel access failures (e.g., a channel access failure threshold, for example for the switching window); and/or a channel busy ratio (CBR) threshold). The WTRU may perform CCA (e.g., to acquire the current FFP). If the CCA fails in a period (e.g., the current FFP), the WTRU may determine if the number of CCA failures in the switching window (e.g., FFP switching window) is greater than a threshold (e.g., the channel access failure threshold).

If the number of CCA failures in the switching window (e.g., FFP switching window) is greater than the channel access failure threshold, the WTRU may determine if a CBR (e.g., a CBR of the resource pool or of the LBT sub-band) is greater than a threshold (e.g., the CBR threshold). If the CBR (e.g., the CBR of the resource pool or of the LBT sub-band) is not greater than the CBR threshold, the WTRU may change to another configuration, for example another FFP configuration (e.g., change an FFP offset and/or and FFP). If the CBR (e.g., the CBR of the resource pool or of the LBT sub-band) is greater than the CBR threshold, the WTRU may switch to another band (e.g., LBT band). A duration of the switching window (e.g., FFP switching window) may be (pre)configured. The WTRU may use the switching window (e.g., FFP switching window) to evaluate the channel status of the system. After a CCA failure (e.g., each CCA failure), the WTRU may (e.g., first) determine the number of CCA failures within the switching window (e.g., FFP switching window, for example the number of CCA failures that occurred during the duration of the FFP switching window). If the number of CCA failures within the switching window (e.g., FFP switching window) is smaller than the (pre)configured failure threshold, the WTRU may continue to use the configuration (e.g., FFP configuration). If the number of CCA failures within the switching window (e.g., FFP switching window) is larger than the (pre)configured threshold, the WTRU may determine whether to switch to another resource pool or sub-band (e.g., LBT sub-band) or change a configuration (e.g., the FFP configuration, for example change the FFP offset and/or FFP periodicity, etc.) based on the CBR (e.g., of the resource pool or of the LBT sub-band). For example, if the CBR (e.g., of the resource pool or of the LBT sub-band) is smaller than a (pre)configured threshold, the WTRU may change a configuration (e.g., the FFP configuration); otherwise, if the CBR (e.g., of the resource pool or of the LBT sub-band) is larger than the threshold, the WTRU may switch to another band (e.g., another LBT sub-band).

A WTRU may receive configuration information that indicates a channel busy ratio (CBR) threshold. The WTRU may determine a CBR value associated with a channel in a listen before talk (LBT) band. The WTRU may compare the CBR value to the CBR threshold. The WTRU may determine a channel access parameter to change based on the comparison of the CBR value to the CBR threshold. The WTRU may change the channel access parameter.

The configuration information may indicate a channel access failure threshold and a fixed frame period (FFP) switching window. The WTRU may (e.g., prior to comparing the CBR value to the CBR threshold) perform a number of channel access attempts associated with the FFP switching window. The WTRU may (e.g., prior to comparing the CBR value to the CBR threshold) determine that the number of channel access attempts satisfies the channel access failure threshold.

Comparing the CBR value to the CBR threshold may involve comparing the CBR value to the CBR threshold based on a number of channel access attempts satisfying the channel access failure threshold. Changing the channel access parameter may involve changing an FFP configuration if the CBR value is less than the CBR threshold. The FFP configuration may include one or more of: an FFP periodicity or an FFP offset value. Changing the channel access parameter may involve switching to a different LBT band or sub-band if the CBR value satisfies the CBR threshold. Changing the channel access parameter may involve changing a resource block set if the CBR value satisfies the CBR threshold.

Feature(s) associated with sidelink feedback are provided herein. A WTRU may request HARQ feedback for a (e.g., one) transmission of a TB. A WTRU may (e.g., determine to) perform a transmission of a HARQ-enabled TB. The WTRU may request the HARQ feedback (e.g., acknowledged (ACK)/not acknowledged (NACK), ACK only, NACK only) for the transmission. The WTRU may request that the Rx WTRU(s) perform HARQ feedback, for example, in one or more (e.g., any combination) of the following period(s): in a (e.g., one) (pre)configured PSFCH occasion in the resource pool; in a current COT and/or FFP (e.g., the Rx WTRU may share the COT with the Tx WTRU); in a future COT and/or FFP; in a (e.g., one) COT and/or FFP of (e.g., one of) the Rx WTRU(s); and/or in a future requested period.

A WTRU may determine period(s) and/or HARQ feedback occasion(s) for which to request HARQ feedback, for example, based on one or more (e.g., any combination) of the following: a QoS of the TB; the remaining number of transmissions of the WTRU in the current COT and/or FFP; whether the Tx WTRU initializes its own COT and/or FFP or is sharing with another node; the remaining COT duration; the gap to the next COT and/or FFP of the Tx WTRU; the gap to the next COT and/or FFP of the Rx WTRU; the availability of a semi-static reservation of a Rx WTRU; the availability of a semi-static reservation of the Tx WTRU; a cast type of the transmission for the TB; and/or the availability of the FFP configuration of the Rx WTRU.

A WTRU may determine period(s) and/or HARQ feedback occasion(s) for which to request HARQ feedback, for example, based on the QoS of the TB. A WTRU may request that the Rx WTRU perform HARQ feedback for a (e.g., one) transmission in a current COT and/or FFP, for example, if the QoS of the TB (e.g., priority, remaining packet delay budget (PDB), etc.) satisfies a criterion (e.g., the priority of the TB is smaller than a threshold, or the remaining PDB of the TB is smaller than a threshold). The WTRU may (e.g., otherwise) request that the Rx WTRU perform HARQ feedback for the transmission in another COT and/or FFP (e.g., the COT and/or FFP of the Rx WTRU or a future COT and/or FFP of the Tx WTRU). A WTRU may (e.g., determine whether to) request that the Rx WTRU perform HARQ feedback in a future requested period, for example, based on the remaining PDB of the TB. A WTRU may request that the Rx WTRU perform HARQ feedback in a future request period, for example, if the remaining PDB of the TB is larger than a threshold. The WTRU may request that the Rx WTRU perform HARQ feedback in another COT and/or FFP (e.g., the current COT and/or FFP of the Tx WTRU), for example, if the remaining PDB of the TB is below (e.g., or equal to) a (e.g., the same) threshold.

A WTRU may determine period(s) and/or HARQ feedback occasion(s) for which to request HARQ feedback, for example, based on the remaining number of transmissions of the WTRU in the current COT and/or FFP. A Tx WTRU may (e.g., determine to) request that the Rx WTRU perform HARQ feedback in a current COT and/or FFP, for example, if the number of remaining transmissions (e.g., the remaining number of transmissions and/or the remaining number of TBs to transmit within the COT) are within a range. The WTRU may request that the Rx WTRU transmit HARQ feedback in other COTs and/or FFPs (e.g., COT and/or FFP of the Rx WTRU or the future COT and/or FFP of the Tx WTRU), for example, if the number of remaining transmission are outside of the range (e.g., including the minimum number of remaining transmissions and/or the maximum number of remaining transmissions).

A WTRU may determine period(s) and/or HARQ feedback occasion(s) for which to request HARQ feedback, for example, based on whether the Tx WTRU initializes the Tx WTRU's own COT and/or FFP or shares a COT and/or FFP with another node. For example, the TX WTRU may request that the Rx WTRU perform HARQ feedback in the current COT and/or FFP (e.g., if the TX WTRU initializes the COT). The Tx WTRU may request that the Rx WTRU perform HARQ feedback in other COTs and/or FFPs (e.g., the COT and/or FFP of the Rx WTRU or the next COT and/or FFP of the Tx WTRU, etc.), for example, if the TX WTRU does not initialize the COT.

A WTRU may determine period(s) and/or HARQ feedback occasion(s) for which to request HARQ feedback, for example, based on the remaining COT duration. The Tx WTRU may request that the Rx WTRU transmit HARQ feedback in its current FFP, for example, if the remaining COT duration is larger than a threshold. The WTRU may request that the Rx WTRU transmit HARQ feedback in another COT and/or FFP (e.g., the COT and/or FFP of the RX WTRU or a future COT and/or FFP of the Tx WTRU), for example, if the remaining COT duration is less than (e.g., or equal to) a (e.g., the same) threshold. One or more thresholds may be (pre)configured, for example, based on the QoS of the TB (e.g., the priority, and/or remaining PDB of the TB).

A WTRU may determine period(s) and/or HARQ feedback occasion(s) for which to request HARQ feedback, for example, based on the gap to the next COT and/or FFP of the Tx WTRU. The WTRU may request that the Rx WTRU perform HARQ feedback in the next COT and/or FFP of the Tx WTRU, for example, if the time gap to the next COT and/or FFP of the Tx WTRU is smaller than a threshold. The WTRU may request that the Rx WTRU feedback in another COT and/or FFP (e.g., the current COT and/or FFP of the Tx WTRU, a future COT and/or FFP of the Rx WTRU), for example, if the time gap to the next COT and/or FFP of the Tx WTRU is larger than (e.g., or equal to) a (e.g., the same) threshold. One or more thresholds may be (pre)configured, for example, based on the QoS of the TB (e.g., the priority, and/or remaining PDB of the TB).

A WTRU may determine period(s) and/or HARQ feedback occasion(s) for which to request HARQ feedback, for example, based on the gap to the next COT and/or FFP of the Rx WTRU. The WTRU may request that the Rx WTRU perform HARQ feedback in the next COT and/or FFP of the Rx WTRU, for example, if the time gap to the next COT and/or FFP of the Rx WTRU is smaller than a threshold. The WTRU may request that the Rx WTRU feedback in another COT and/or FFP (e.g., the current COT and/or FFP of the Tx WTRU, a future COT and/or FFP of the Tx WTRU), for example, if the time gap to the next COT and/or FFP of the Rx WTRU is larger than (e.g., or equal to) a (e.g., the same) threshold. One or more thresholds may be (pre)configured, for example, based on the QoS of the TB (e.g., the priority, and/or remaining PDB of the TB).

A WTRU may determine period(s) and/or HARQ feedback occasion(s) for which to request HARQ feedback, for example, based on the availability of a semi-static reservation of an Rx WTRU. The Tx WTRU may (e.g., determine to) request that the Rx WTRU perform HARQ feedback for a Tx WTRU transmission in the COT and/or FFP of the Rx WTRU, for example, based on whether the Rx WTRU reserves one or more semi-static resources. The Tx WTRU may (e.g., determine to) request that the Rx WTRU perform HARQ feedback in the COT and/or FFP of the RX WTRU, for example, if the earliest COT and/or FFP of the Rx WTRU is, for example, smaller than a threshold. The threshold may be (pre)configured, for example, based on the QoS of the TB (e.g., the priority, and/or remaining PDB of the TB).

A WTRU may determine period(s) and/or HARQ feedback occasion(s) for which to request HARQ feedback, for example, based on the availability of a semi-static reservation of the Tx WTRU. The Tx WTRU may (e.g., determine to) request that the Rx WTRU perform HARQ feedback in one of the COTs and/or FFPs of the Tx WTRU, for example, if the Tx WTRU has one or more semi-static reservation resources.

A WTRU may determine period(s) and/or HARQ feedback occasion(s) for which to request HARQ feedback, for example, based on a cast type of the transmission for the TB. For example, the WTRU (e.g., Tx WTRU) may (e.g., determine to) request that the Rx WTRU(s) perform HARQ feedback in a future COT and/or FFP or in a COT and/or FFP of the Rx WTRU for unicast transmission. The WTRU may (e.g., determine to) request (e.g., for groupcast transmission) that the Rx WTRU perform HARQ feedback in a future COT and/or FFP of the Tx WTRU.

A WTRU may determine period(s) and/or HARQ feedback occasion(s) for which to request HARQ feedback, for example, based on the availability of the FFP configuration of the Rx WTRU. The WTRU may request that the Rx WTRU perform HARQ feedback in a COT and/or FFP of the Tx WTRU, for example, if the FFP configuration of the Rx WTRU are not available. The Tx WTRU may request that the Tx WTRU perform HARQ feedback in a COT and/or FFP of the Tx or Rx WTRUs, for example, if the FFP configuration of the Rx WTRU are available.

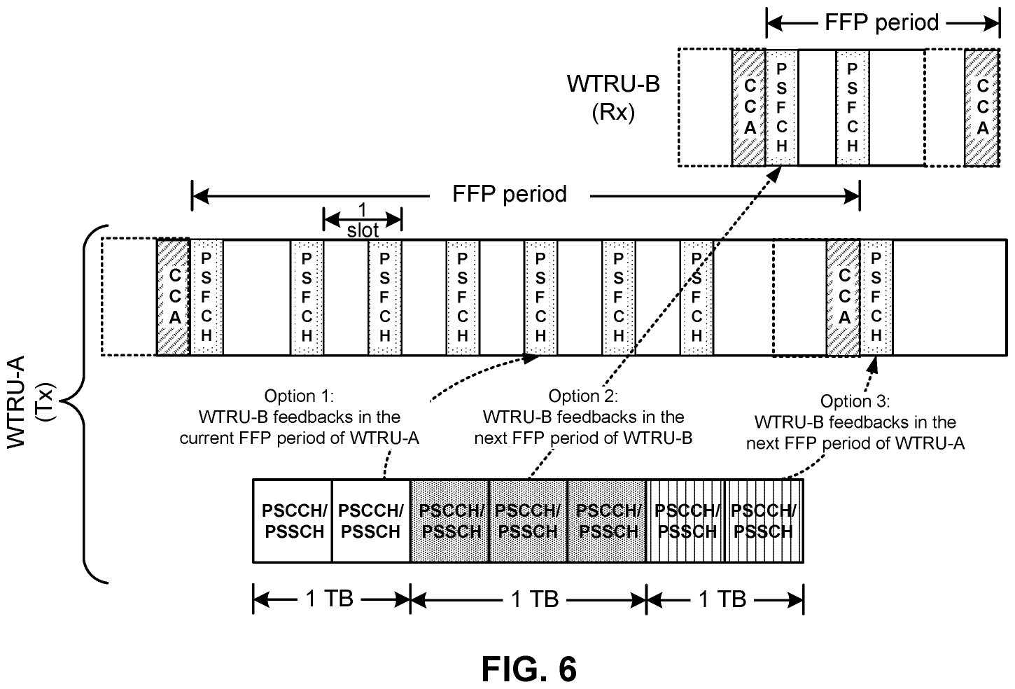

FIG. 6 illustrates an example of HARQ feedback options for a transmission requiring HARQ feedback. As shown by example in FIG. 6, WTRU-A may initialize its COT in one COT and/or FFP. A WTRU (e.g., WTRU-A) may have, for example, three (3) TBs to transmit in the COT and/or FFP. WTRU-A may request that an Rx WTRU (e.g., WTRU-B) perform HARQ feedback, for example, in one of three options. In an example of a first option (Option 1), WTRU-A may request that WTRU-B perform HARQ feedback in the current COT and/or FFP of the Tx WTRU. In an example of a second option (Option 2), WTRU-A may request that WTRU-B perform HARQ feedback in a COT and/or FFP of WTRU-B. In a third option (Option 3), WTRU-A may request that WTRU-B perform HARQ feedback in the next COT and/or FFP of the Tx WTRU.

A WTRU may determine a PSFCH occasion and/or a PSFCH resource. A WTRU (e.g., Tx WTRU) may determine COT(s) and/or FFP(s) in which to perform HARQ feedback, for example, for transmission of a TB. A WTRU may determine a PSFCH occasion in which to perform HARQ feedback (e.g., which slot in a COT and/or FFP). A WTRU may determine a PSFCH resource in a PSFCH occasion for which to perform HARQ feedback. In some examples, the WTRU may be (pre)configured with a (e.g., an implicit) mapping between the PSCCH/PSSCH and the PSFCH resource. In some examples, the Tx WTRU may determine the PSFCH resource. In some examples, the Tx WTRU may determine the COT and/or FFP, and/or the Rx WTRU may determine the PSFCH occasion and/or PSFCH resource in the PSFCH occasion. In some examples, the Tx WTRU may determine the COT and/or FFP and/or PSFCH occasion, and/or the Rx WTRU may determine the PSFCH resource within the indicated PSFCH occasion.

A WTRU (e.g., Tx or Rx WTRU) may determine a PSFCH occasion and/or PSFCH resource for which to perform HARQ feedback, for example, based on one or more (e.g., any combination) of the following: a slot index of PSCCH/PSSCH; a resource index of PSCCH/PSSCH (e.g., interlace index) within the slot; a number of interlaces per PSCCH/PSSCH slot; a time gap between the PSCCH/PSSCH and the PSFCH slot; a destination ID associated with the PSCCH/PSSCH transmission; a source ID of the Tx WTRU; a member ID of the Rx WTRU (e.g., for groupcast communication); a WTRU ID of the Rx WTRU; a COT and/or FFP associated with the HARQ feedback resource; one or more FFP configuration parameters of the FFP associated with the HARQ feedback resource; and/or an order of the HARQ feedback attempt for the transmission.

A Tx WTRU may indicate the maximum number of HARQ feedback attempts. In some examples, a WTRU (e.g., Tx WTRU) may request that the Rx WTRU access the channel one or more times to perform HARQ feedback. The Tx WTRU may indicate one or more (e.g., any combination) of the following information to the Rx WTRU for HARQ feedback of a (e.g., one) transmission: a maximum number of HARQ feedback attempts; a window of HARQ feedback; and/or the maximum latency for a HARQ feedback. For example, a Tx WTRU may indicate a maximum number of HARQ feedback attempts to an Rx WTRU. The Tx WTRU may trigger a resource allocation for retransmission of the TB, for example, if the Tx WTRU has not received HARQ ACK feedback from the Rx WTRU after the maximum number of HARQ occasions.

One or more (e.g., any combination) of parameters (e.g., indicated by the Tx WTRU to the Rx WTRU) may be determined, for example, based on one or more (e.g., any combination) of the following: the QoS of the TB (e.g., the priority of the TB, and/or the remaining PDB of the TB); and/or the PSFCH configuration in a (e.g., one) COT and/or FFP. For example, the WTRU may indicate the maximum latency for a HARQ feedback, which may be a function of the remaining PDB of the TB (e.g., half of the remaining PDB). For example, the WTRU may determine the maximum number of HARQ feedback attempts based on the number of PSFCH occasions per period.

A WTRU may perform retransmission for a TB based on the HARQ feedback status. A WTRU (e.g., Tx WTRU) may indicate/be (pre)configured with multiple HARQ feedback occasions for a (e.g., one) transmission of a TB. The WTRU may (e.g., determine to) perform retransmission of the TB, for example, based on a HARQ feedback status for a previous transmission of the TB. A WTRU may perform retransmission of the TB, for example, based on one or any combination of the following: the WTRU has not received HARQ ACK feedbacks for at least N occasions; the WTRU has not received HARQ ACK feedback in N COTs and/or FFPs (e.g., N=1); and/or the WTRU has acquired a channel in another COT and/or FFP (e.g., for transmission of another TB).

A WTRU may perform retransmission of the TB, for example, if the WTRU has not received HARQ ACK feedbacks for at least N occasions. The value of N may be determined, for example, based on the QoS of the TB (e.g., priority, and/or the remaining PDB of the TB). The value of N may be conveyed to the Rx WTRU in the transmission requesting the HARQ feedback.

A WTRU may perform retransmission of the TB, for example, if the WTRU has not received HARQ ACK feedback in N COTs and/or FFPs (e.g., N=1). For example, the WTRU may request that the WTRU perform HARQ feedback in its current COT and/or FFP. The WTRU may perform retransmission in a future COT and/or FFP, for example, if the WTRU has not received HARQ ACK feedback in (e.g., all) occasions of the current COT and/or FFP.

A WTRU may perform retransmission of the TB, for example, if the WTRU has acquired a channel in another COT and/or FFP (e.g., for transmission of another TB). For example, a WTRU may not receive HARQ ACK feedback for a transmission of a TB. The WTRU may (e.g., then) acquire the channel in another COT and/or FFP. In some examples, the WTRU may perform retransmission of the TB in the newly acquired channel of the new COT and/or FFP and perform retransmission of the TB. In some examples, the WTRU may determine whether to perform retransmission of the TB based on one or any combination of the following: the remaining PDB of the TB; and/or the priority of the TB.

A WTRU may determine whether to perform retransmission of the TB, for example, based on the remaining PDB of the TB. The WTRU may perform retransmission of the TB, for example, if the remaining PDB of the TB is smaller than a threshold. The WTRU may not perform retransmission for the TB in the current COT and/or FFP, for example, if the remaining PDB of the TB is larger than the threshold. The threshold may be (pre)configured, for example, based on the QoS of the TB (e.g., the priority, and/or remaining PDB of the TB).

A WTRU may determine whether to perform retransmission of the TB, for example, based on the priority of the TB. The WTRU may perform retransmission of the TB, for example, if the remaining PDB of the TB is smaller than a threshold. The WTRU may not perform retransmission for the TB in the current COT and/or FFP, for example, if the remaining PDB of the TB is larger than the threshold. The threshold may be (pre)configured, for example, based on the QoS of the TB (e.g., the priority, and/or remaining PDB of the TB).

A WTRU may determine when to terminate a HARQ feedback attempt for a (e.g., one) transmission. In some examples, a WTRU (e.g., Tx WTRU, Rx WTRU) may have multiple HARQ feedback attempts to transmit HARQ feedback of a transmission to the Tx WTRU. The Rx WTRU may (e.g., sequentially) attempt to access the channel (e.g., by performing CCA) in each HARQ feedback attempt occasion. The WTRU may attempt to access the channel in the next HARQ feedback attempt occasion (e.g., in the next COT and/or FFP), for example, if the WTRU fails to access the channel in a (e.g., one) HARQ feedback attempt occasion. The WTRU may stop the procedure, for example, based on one or more (e.g., any combination of) events described herein and/or one or more (e.g., any combination) of the following events: the WTRU successfully transmits HARQ feedback in an (e.g., one) occasion; the WTRU has reached the maximum number of HARQ feedback attempts (e.g., the WTRU may report the channel access failure to another node, such as a gNB, for example, if the WTRU fails to access the channel after the maximum number of HARQ feedback attempts); and/or the WTRU has reached the maximum HARQ feedback latency.

A WTRU may determine COTs and/or FFPs for which to perform HARQ feedback of a (e.g., one) transmission. A WTRU (e.g., Rx WTRU) may (e.g., be allowed to) perform HARQ feedback for a (e.g., one) transmission of a TB in multiple COTs and/or FFPs, which may include one or more (e.g., any combination) of the following COTs and/or FFPs/occasions: in one (pre)configured PSFCH occasion in the resource pool; in a current COT and/or FFP (e.g., the Rx WTRU may share the COT with the Tx WTRU); in a future COT and/or FFP; in a (e.g., one) COT and/or FFP of an (e.g., one of the) Rx WTRU(s); and/or in a future requested period.

A WTRU (e.g., Rx WTRU) may determine COTs and/or FFPs/occasions in which to perform HARQ feedback, for example, based on one or more (e.g., any combination) of the following: an indication from the Tx WTRU; the availability of the data in the buffer (e.g., the WTRU may determine to perform HARQ feedback in a COT and/or FFP if the WTRU has data to transmit); the availability of data in the buffer targeting the Tx WTRU (e.g., the WTRU may determine to perform HARQ feedback in a COT and/or FFP if the WTRU has data to transmit to the Tx WTRU); the availability of a reservation resource of the WTRU (e.g., the WTRU may determine to perform HARQ feedback in a COT and/or FFP if the WTRU has a semi-persistent resource reserved).

A Tx WTRU may indicate information about a HARQ feedback of a transmission. A WTRU (e.g., Tx WTRU) may indicate to another WTRU (e.g., Rx WTRU) one or more (e.g., any combination) of the following information about HARQ feedback of a transmission: a PSFCH configuration in the COT and/or FFP of the WTRU; COTs and/or FFPs in which to transmit HARQ feedback of a transmission; a HARQ feedback occasion; a HARQ resource in the COT and/or FFP; a HARQ feedback resource of a HARQ feedback occasion; a HARQ ID(s); and/or a CCA/LBT period (e.g., no CCA/LBT, fixed CCA/LBT duration such as 9 μs, 16 μs, or 25 μs and/or flexible CCA/LBT duration) before the PSFCH occasion.

A WTRU may use one or more (e.g., any combination) of the following to send a message to convey information about HARQ feedback: SCI (e.g., 2^{nd} SCI or 3^{rd} SCI); MAC CE; and/or PC5 RRC. A WTRU may use an SCI (e.g., 2^{nd} SCI or 3^{rd} SCI) message to convey information about HARQ feedback. For example, the WTRU (e.g., Tx WTRU) may use SCI to indicate the COT and/or FFP, HARQ occasion, and/or HARQ resource to perform HARQ feedback. A WTRU may use a MAC CE message to convey information about HARQ feedback. For example, the WTRU may use a MAC CE message to request that the Rx WTRU feedback the status of multiple HARQ IDs. A WTRU may use a PC5 RRC message to convey information about HARQ feedback. For example, the WTRU may send a PSFCH configuration and CCA period using PC5 RRC.

An Rx WTRU may perform (e.g., provide) HARQ feedback to the Tx WTRU(s). An Rx WTRU may use one or more (e.g., any combination) of the following messages to perform HARQ feedback for one or more transmissions of one or more TBs/HARQ process identifiers (HARQ IDs): PSFCH; SCI (e.g., 2^{nd} SCI or 3^{rd} SCI); MAC CE; and/or PC5 RRC.

A WTRU (e.g., Rx WTRU) may determine a message in which to send HARQ feedback to the Tx WTRU, for example, based on one or more (e.g., any combination) of the following: a COT and/or FFP in which the WTRU performs HARQ feedback; and/or the number of HARQ IDs to feedback to the Tx WTRU.

A WTRU (e.g., Rx WTRU) may determine a message in which to send HARQ feedback to the Tx WTRU, for example, based on the COT and/or FFP in which the WTRU performs HARQ feedback. The WTRU may use PSFCH, for example, if the WTRU performs HARQ feedback for a (e.g., one) transmission in the FFP of the Tx WTRU. The WTRU may use SCI, MAC CE, and/or PC5 RRC to feedback the status of one or more HARQ IDs to the Tx WTRU, for example, if the WTRU does not perform HARQ feedback for a (e.g., one) transmission in the FFP of the Tx WTRU.

A WTRU (e.g., Rx WTRU) may determine a message in which to send HARQ feedback to the Tx WTRU, for example, based on the number of HARQ IDs to feedback to the Tx WTRU. For example, the WTRU may be requested to feedback the status of multiple HARQ IDs to the Tx WTRU. The WTRU may use, for example, SCI, MAC CE, and/or PC5 RRC, to feedback the status of those HARQ IDs.

A Tx WTRU may indicate the maximum number of HARQ feedback attempts. In some examples, a WTRU (e.g., Tx WTRU) may request that the Rx WTRU access the channel one or more times to perform HARQ feedback. The Tx WTRU may indicate one or more (e.g., any combination) of the following information to the Rx WTRU for HARQ feedback of a (e.g., one) transmission: the maximum number of HARQ feedback attempts; the window of HARQ feedback; and/or the maximum latency for a HARQ feedback.

One or more (e.g., any combination) of the parameters may be determined, for example, based on one or more (e.g., any combination) of the following: the QoS of the TB (e.g., the priority of the TB, and/or the remaining PDB of the TB); and/or the PSFCH configuration in a (e.g., one) COT and/or FFP. One or more (e.g., any combination) of the parameters may be determined, for example, based on the QoS of the TB (e.g., the priority of the TB, and/or the remaining PDB of the TB). For example, the WTRU may indicate the maximum latency for a HARQ feedback, which may be a function of the remaining PDB of the TB (e.g., half of the remaining PDB). One or more (e.g., any combination) of the parameters may be determined, for example, based on the PSFCH configuration in one COT and/or FFP. For example, the WTRU may determine the maximum number of HARQ feedback attempts based on the number of PSFCH occasions per period.

A WTRU may determine a HARQ feedback occasion in which to perform HARQ feedback for a (e.g., one) transmission. A WTRU (e.g., Rx WTRU) may (e.g., be allowed to) perform HARQ feedback for a (e.g., one) transmission of a TB in multiple HARQ feedback occasions. A WTRU may (e.g., determine to) access the channel in one or more (e.g., all) feedback occasions in a timing order and/or perform HARQ feedback, for example, if the WTRU acquires the channel. A WTRU may determine a HARQ feedback occasion to feedback, for example, based on one or more (e.g., any combination) of the following: the availability of the data in the buffer; the availability of the data in the buffer targeting the Tx WTRU; and/or the availability of a reservation resource of the WTRU.

A WTRU may determine a HARQ feedback occasion to feedback, for example, based on the availability of the data in the buffer. For example, a WTRU may (e.g., if the WTRU has data to transmit) perform HARQ feedback for the transmission in a (e.g., one) PSFCH occasion, in which the WTRU performs a PSCCH/PSSCH transmission. A WTRU may (e.g., if the WTRU does not have data to transmit) perform HARQ feedback in an (e.g., the first) PSFCH occasion of the WTRU's COT and/or FFP, which may occur at the beginning of the COT and/or FFP.

A WTRU may determine a HARQ feedback occasion to feedback, for example, based on the availability of data in the buffer targeting the Tx WTRU. For example, the WTRU may piggyback the HARQ feedback in the transmission to the Tx WTRU (e.g., in SCI, or MAC CE of the transmission to the Tx WTRU).

A WTRU may determine a HARQ feedback occasion to feedback, for example, based on the availability of a reservation resource of the WTRU. A WTRU may perform HARQ feedback in the same slot with a (e.g., one) reservation period (e.g., at the end of the slot), for example, if the WTRU has one or more resources reserved.

A WTRU may request HARQ feedback in a current COT and/or FFP. For example, a Tx WTRU may request that an Rx WTRU perform HARQ feedback in a current COT and/or FFP of the Tx WTRU. In some examples, a Tx WTRU may indicate the PSFCH occasion and PSFCH resource to an Rx WTRU. In some examples, a Tx WTRU may indicate the PSFCH occasion to an Rx WTRU. The Rx WTRU may (e.g., then) determine the PSFCH resource, for example, based on one or more (e.g., any combination) of the following: a time gap between the PSFCH and the PSCCH/PSSCH; a number of interlaces per PSCCH/PSSCH slot; a slot index of PSCCH/PSSCH; a resource index of PSCCH/PSSCH (e.g., interlace index) within the slot; a time gap between the PSCCH/PSSCH and the PSFCH slot; a destination ID associated with the PSCCH/PSSCH transmission; a source ID of the Tx WTRU; a member ID of the Rx WTRU (e.g., for groupcast communication); and/or a WTRU ID of the Rx WTRU.

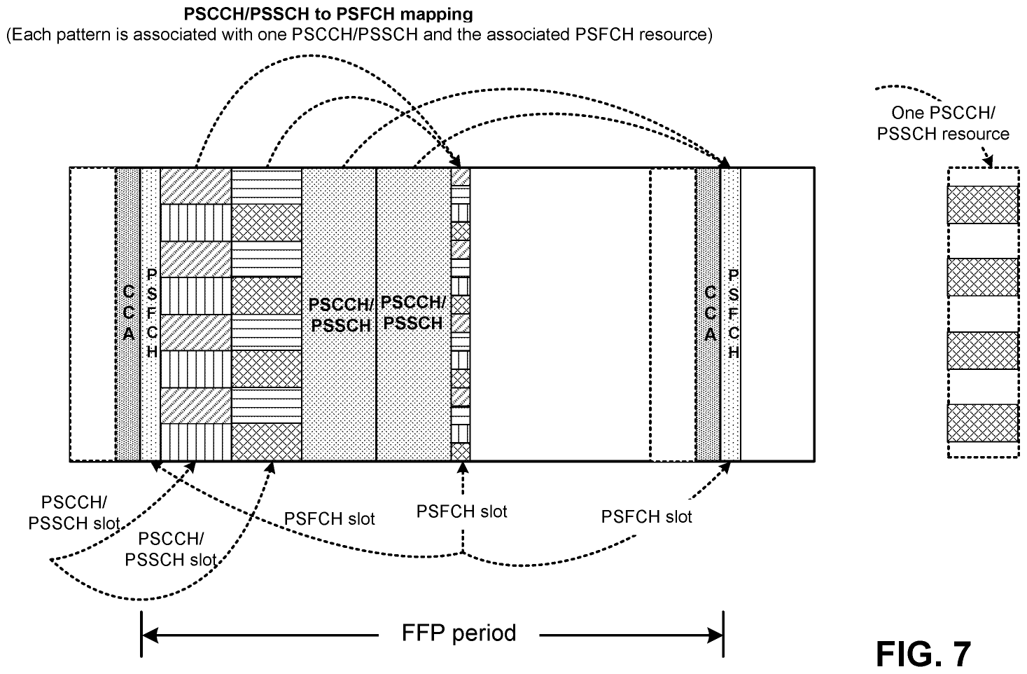

FIG. 7 illustrates an example of an implicit mapping rule between PSCCH/PSSCH and a PSFCH resource. As illustrated in FIG. 7, a Tx WTRU may request an Rx WTRU to perform HARQ feedback at the end of a COT. The Rx WTRU may determine the PSFCH resource in the PSFCH occasion, for example, based on the implicit mapping rule between PSCCH/PSSCH and a PSFCH resource.

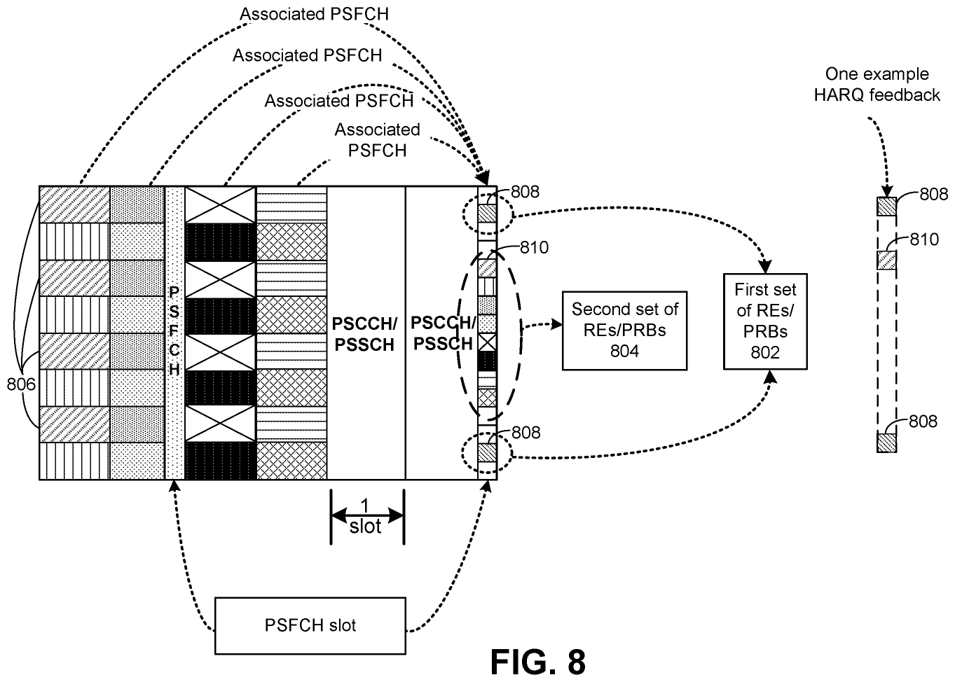

FIG. 8 illustrates an example of a WTRU determining the set of REs/PRBs on which to feedback the associated PSCCH/PSSCH. The WTRU may determine the set of REs/PRBs on which to transmit HARQ feedback. In a PSFCH occasion (e.g., PSFCH slot) the WTRU may be configured with sets of REs/PRBs (e.g., two sets of REs/PRBs) on which to transmit HARQ feedback. The first set of REs/PRBs may be used for a WTRU (e.g., any WTRU) transmitting PSFCH in the slot and the other set of REs/PRBs may be used by the WTRU to feedback HARQ status (e.g., HARQ ACK/NACK) associated with the PSCCH/PSSCH. The WTRU may determine a subset of REs/PRBs in the second set of REs/PRBs for which to feedback the HARQ status of the associated PSCCH/PSSCH based on one or more of the following: the interlace index of the PSCCH/PSSCH; the slot index of the PSCCH/PSSCH; the number of slots associated with the PSFCH; the number of PRBs/REs in the second set of REs/PRBs configured in one PSFCH slot; the source ID of the associated PSCCH/PSSCH; the destination ID of the associated PSCCH/PSSCH; a cast type of the TB; or the member ID and the number of member in the group for groupcast option 2. For HARQ transmission, the WTRU may transmit on the REs/PRBs (e.g., both the REs/PRBs) in the first and the second set of REs/PRBs. The WTRU may transmit a default sequence in the first set of REs/PRBs. The sequence to transmit in the subset of REs/PRBs in the second set may be used to convey HARQ ACK or HARQ NACK feedback. This may help the WTRU fulfill the Occupation Channel Bandwidth (OCB) requirements for PSFCH transmission. As shown in FIG. 8, the WTRU may be (pre)configured with sets (e.g., two sets) of REs/PRBs in a PSFCH slot, the first set of REs/PRBs 802 and the second set of REs/PRBs 804. A PSFCH occasion (e.g., each PSFCH occasion) may have 4 PSCCH/PSSCH slots. The WTRU may determine REs/PRBs for which to feedback an associated PSCCH/PSSCH based on the location of the PSCCH/PSSCH and the mapping function between PSCCH/PSSCH and PSFCH. For example, the Rx WTRU may receive PSCCH/PSSCH in the interlace 806 and may determine the PRBs in the second set of REs/PRBs. The Rx WTRU may provide the HARQ feedback for the associated PSCCH/PSSCH transmission in the interlace 806. Specifically, the WTRU may perform HARQ ACK/NACK transmission occupying two PRBs 808 in the first set of REs/PRBs and one PRB 810 in the second set of REs/PRBs. The two PRBs 808 may be used to fulfill the OCB requirement. The PRB 810 may be used to convey the ACK or NACK bit.

A WTRU may determine a transmission type for a TB. A WTRU may be (pre)configured, for example, with one or more (e.g., any combination) of the following LCHs/SLRBs (e.g., regarding a HARQ feedback option of one or more transmissions of a TB having each LCH): HARQ enabled LCH/SLRB; HARQ disabled LCH/SLRB; and/or HARQ mixture LCH/SLRB. A WTRU may be (pre)configured with a HARQ-enabled LCH/SLRB. A WTRU may not request HARQ feedback for a (e.g., any) transmission of the TB for transmissions of the TB including a HARQ-enabled type of LCH/SLRB. A WTRU may be (pre)configured with a HARQ disabled LCH/SLRB. In some examples, a WTRU may request HARQ feedback for a (e.g., each) transmission of the TB for transmissions of the TB including a HARQ-disabled type of LCH/SLRB. A WTRU may be (pre)configured with a HARQ mixture LCH/SLRB. In some examples, a WTRU may request HARQ feedback for a (e.g., one) set of transmissions and may not request HARQ feedback for another set of transmissions for transmissions of the TB including a HARQ mixture type of LCH/SLRB.

A WTRU may perform a logical channel prioritization (LCP) restriction for different types of LCHs/SLRBs. A WTRU may perform an LCP restriction for different types of HARQ feedback LCHs/SLRBs. In some examples, a WTRU may restrict a (e.g., each) type of LCH/SLRB to be multiplexed. A WTRU may allow HARQ-enabled LCH/SLRB and HARQ mixture LCH/SLRB to be multiplexed. The WTRU may consider a multiplexed TB to be a HARQ mixture TB, in which the WTRU may request HARQ feedback for a (e.g., one) set of transmission and may not request HARQ feedback for another set of transmission. A WTRU may consider a multiplexed TB as a HARQ-enabled TB, in which the WTRU may request HARQ feedback for one or more (e.g., any) transmissions of the TB.

A WTRU may determine whether to request HARQ feedback for a (e.g., one) transmission of a TB. In some examples, a WTRU may perform one or more transmissions for a (e.g., one) HARQ enabled TB. The WTRU may (e.g., determine to) perform HARQ mixture transmissions for the TB, for example, if the WTRU requests HARQ feedback for a (e.g., one) set of transmissions and the WTRU does not request HARQ feedback for another set of transmissions for a TB. The WTRU may (e.g., then) determine whether to request that the Rx WTRU perform HARQ feedback for a (e.g., one) transmission based on one or more (e.g., any combination) of the following: the order of the transmission in the TB; and/or the time gap to the PSFCH slot in the current COT of the Tx WTRU.

A WTRU may determine whether to request that an Rx WTRU perform HARQ feedback for a transmission based on the order of the transmission in the TB. For example, the WTRU may perform contiguous transmission of a TB. The WTRU may not request that the Rx WTRU perform HARQ feedback for the initial and/or one or more middle transmissions. If the WTRU does not request HARQ feedback, the WTRU may implicitly or explicitly indicate in the SCI (e.g., 2^{nd} SCI) that HARQ feedback is not required for the transmission. The WTRU may request that the Rx WTRU perform HARQ feedback for the last transmission of the TB in the COT. If the WTRU requests HARQ feedback, the WTRU may implicitly/explicitly indicate in the SCI (e.g., 2^{nd} SCI) that HARQ feedback is required for the transmission.

A WTRU may determine whether to request that an Rx WTRU perform HARQ feedback for a transmission based on the time gap to the PSFCH slot in the current COT of the Tx WTRU. For example, the WTRU may perform contiguous transmission of a TB. The WTRU may determine a transmission of the TB in the FFP for which to request HARQ feedback, for example, based on the time gap between the transmission and the PSFCH occasion. The WTRU may select a (e.g., one) transmission to request HARQ feedback with a time gap between the transmission slot and PSFCH slot that is larger than a threshold. The threshold may be determined, for example, based on the WTRU processing capability (e.g., the threshold may be 2 or 3 slots).

A WTRU may determine whether to perform CCA for a PSFCH occasion. A WTRU may be requested/indicated to perform PSFCH in an occasion (e.g., one occasion). The WTRU may not perform CCA. The WTRU may (e.g., directly) perform PSFCH transmission in the indicated occasion. The WTRU may perform CCA before the PSFCH occasion to determine the availability of the channel before performing the PSFCH transmission. The WTRU may determine the CCA/LBT duration (e.g., no CCA/LBT, first duration CCA/LBT, second duration CCA/LBT, flexible duration CCA/LBT, etc.) before a (e.g., one) PSFCH occasion, for example, based on one or more (e.g., any combination) of the following: a pre-configuration in the resource pool; an indication from the Tx WTRU; the availability of the transmission from another WTRU in the current slot; and/or the QoS of the TB (e.g., priority, remaining PDB of the TB). For example, the WTRU (e.g., Rx WTRU) may be (pre)configured with a resource pool with periodic PSFCH slots. The WTRU may be (pre)configured to perform CCA/LBT for a fixed duration (e.g., 9 μs/16 μs/25 μs) before transmission of HARQ feedback. The WTRU may follow the resource pool configuration to determine the CCA/LBT duration. The WTRU may transmit HARQ feedback if the channel is idle; otherwise, the WTRU may not transmit HARQ feedback in that slot.

A WTRU may determine a CCA duration before a (e.g., one) PSFCH occasion, for example, based on an indication from the Tx WTRU.

A WTRU may determine a CCA duration before a (e.g., one) PSFCH occasion, for example, based on the availability of the transmission from another WTRU in the current slot. A WTRU may (e.g., determine to) not perform CCA, for example, if the WTRU detects (e.g., via SCI decoding, and/or a received signal strength indicator (RSSI) measurement(s)) that a (e.g., one) WTRU performs transmission in a current slot. The WTRU may determine to perform CCA, for example, if the WTRU does not detect that a (e.g., any) WTRU in the system is performing a transmission in the current slot. A WTRU may (e.g., determine to) not perform CCA, for example, if the WTRU detects a (e.g., one) WTRU reserving a resource in a current slot. The transmission reserving the resource in the current slot may occur in the same COT and/or FFP of the current slot. The WTRU may perform CCA, for example, if the WTRU does not detect a (e.g., any) WTRU performing a transmission in the current COT and/or FFP reserving a transmission in the current slot of PSFCH.

A WTRU may determine a CCA duration before a (e.g., one) PSFCH occasion, for example, based on the QoS of the TB (e.g., priority, remaining PDB of the TB). A WTRU may (e.g., determine to) not perform CCA, for example, if the priority of the TB is higher than a threshold. The WTRU may perform CCA, for example, if the priority of the TB is less than (e.g., or equal to) a (e.g., the same) threshold. The WTRU may defer PSFCH transmission, for example, if a CCA is not cleared. The threshold of the priority of the TB may be (pre)configured.

A WTRU may determine whether to puncture/rate-match a PSCCH/PSSCH in a PSFCH slot. A WTRU (e.g., Tx WTRU) may perform PSCCH/PSSCH in a slot that may have a (e.g., potential) PSFCH transmission. The WTRU may determine whether to rate-match/puncture a (e.g., one) portion of a PSCCH/PSSCH resource (e.g., in a CCA period and/or an overlapping region with PSFCH) based on whether there is a (e.g., any) PSFCH scheduled in the slot. The WTRU may rate-match/puncture a (e.g., one) portion of PSCCH/PSSCH, for example, if the WTRU determines that there is one or more PSFCH scheduled in the slot. The WTRU may not rate-match/puncture the PSCCH/PSSCH, for example, if the WTRU determines that PSFCH is not scheduled in the slot. A WTRU may determine whether there are one or more PSFCH scheduled in a slot, for example, based on one or more (e.g., any combination) of the following: whether the COT is sharable in the frequency domain; whether the WTRU indicates another WTRU to perform PSFCH transmission in the slot; and/or whether the WTRU detects any other WTRU indicating a PSFCH transmission in the slot. For example, in one of its transmissions, the WTRU may indicate/request that the receiver WTRU report PSFCH in the current slot. The WTRU may expect to receive PSFCH in the current slot. The WTRU may puncture/rate-match PSCCH/PSSCH for one or more symbols to receive PSFCH. For example, in the slot associated with the PSFCH, the WTRU may perform transmission, which does not use (e.g., require) the Rx WTRU to give feedback. The WTRU may determine not to rate-match/puncture its PSCCH/PSSCH transmission in the current slot for PSFCH transmission. The WTRU may not expect to receive PSFCH. For example, the WTRU may monitor the channel in the slot(s) having associated PSFCH in the current slot. In examples, the WTRU may determine to rate-match/puncture PSCCH/PSSCH in one or more symbols of the current slots if it detects transmission from another WTRU transmitting HARQ-enabled TB in the monitored slot(s). The WTRU may not rate-match/puncture PSCCH/PSSCH in the current slot if the WTRU does not detect any transmission in the previous slot(s) having associated PSFCH in the current slot.

A WTRU may determine whether there may be one or more PSFCH scheduled in a slot, for example, based on whether the COT is sharable in the frequency domain. The WTRU may (e.g., determine to) puncture/rate-match a (e.g., one) portion of PSCCH/PSSCH in the slot, for example, if the COT is sharable. The WTRU may (e.g., if the COT is not sharable) determine whether to puncture/rate-match a (e.g., one) portion of PSCCH/PSSCH in the slot, for example, based on whether the WTRU requests any other WTRU to perform PSFCH transmission in the slot. The WTRU may puncture/rate-match the (e.g., one) portion of PSCCH/PSSCH transmission, for example, if the WTRU indicates/requests for another WTRU to perform PSFCH transmission in the slot. The WTRU may not puncture/rate-match the PSCCH/PSSCH in the slot, for example, if the WTRU does not indicate/request another WTRU to perform PSFCH transmission in the slot.

A WTRU may determine whether there are one or more PSFCH scheduled in a slot, for example, based on whether the WTRU indicates for another WTRU to perform PSFCH transmission in the slot. A WTRU may determine whether there are one or more PSFCH scheduled in a slot, for example, based on whether the WTRU detects any other WTRU indicating PSFCH transmission in the slot.

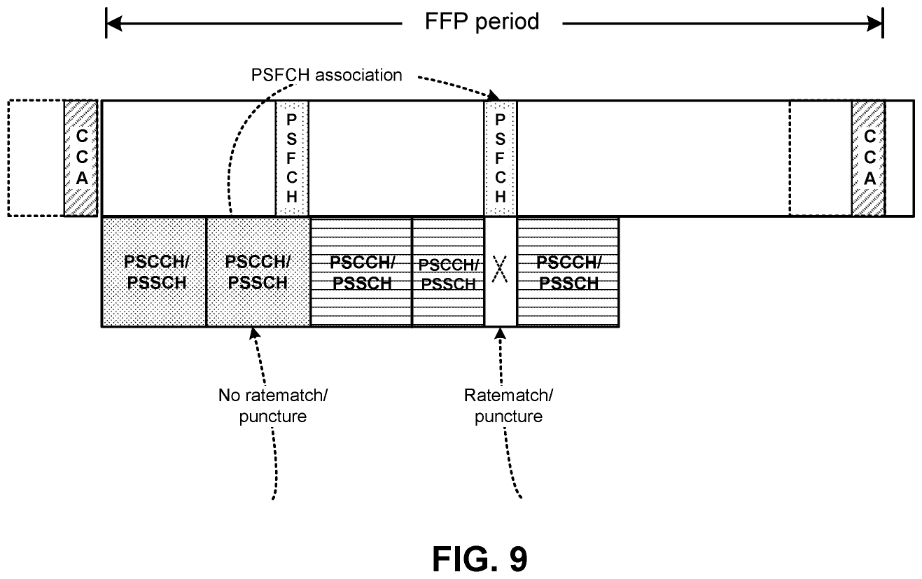

FIG. 9 illustrates an example of a WTRU determination whether to puncture/rate-match a (e.g., one) PSCCH/PSSCH. As illustrated in FIG. 9, the WTRU may have one or more (e.g., two) PSFCH occasions in the WTRU's COT and/or FFP. The WTRU may determine not to puncture/rate-match the PSCCH/PSSCH in the slot of the first PSFCH, for example, if a WTRU is not performing a PSFCH transmission in the first PSFCH. The WTRU may determine to puncture/rate-match PSCCH/PSSCH in the slot of the second PSFCH, for example, if the WTRU has requested that a (e.g., one) WTRU perform PSFCH transmission in an (e.g., one) early transmission.

The WTRU may resume its COT/FFP after a PSFCH resource. The WTRU may stop/pause its transmission for another WTRU to perform LBT/CCA and/or transmit PSFCH. The WTRU may resume its transmission after a (pre)configured period (e.g., for PSFCH transmission/reception period). The WTRU may perform CCA/LBT to clear a channel before the resumed resource. In examples, the WTRU may perform one type of CCA/LBT (e.g., fixed CCA/LBT for a duration of 9 μs/16 μs/25 μs) to resume its transmission after the PSFCH. The CCA/LBT duration may be fixed or (pre)configured in the resource pool. In examples, the WTRU may perform different types of CCA/LBT based on one or more conditions. The WTRU may determine one or more CCA/LBT parameters (e.g., CCA/LBT duration including no CCA/LBT, fixed CCA/LBT duration, and/or flexible CCA/LBT duration) to use to perform CCA/LBT after the pause duration based on one or more of the following. The WTRU may determine one or more CCA/LBT parameters based on the QoS associated with its data. For example, the WTRU may perform a fixed LBT/CCA duration if QoS of the TB is smaller than a threshold; otherwise, the WTRU may perform flexible LBT/CCA duration (e.g., type 1 LBT) if the QoS of the TB is larger than a threshold. The WTRU may determine one or more CCA/LBT parameters based on one or more CCA/LBT parameters used to acquire the COT/FFP. For example, the WTRU may not perform LBT/CCA if the WTRU uses type 1 LBT to acquire the channel. Otherwise, if the WTRU shares the COT/FFP of another WTRU, the WTRU may use type 2 LBT (e.g., type 2A or type 2B) to sense the channel after the pause duration. For example, the WTRU may use type 1 LBT if the contention window (e.g., CWₚ) the minimum, and/or the maximum contention window associated with the channel access priority class p (e.g., CWₚ, CW_{min,p}, and CW_{max,p}) is smaller than a threshold. Otherwise, the WTRU may use type 2 LBT. The WTRU may determine one or more CCA/LBT parameters based on CBR of the resource pool. The WTRU may use one type of LBT/CCA if the CBR is smaller than a threshold (e.g., type 1 LBT). Otherwise, the WTRU may use another type of LBT/CCA (e.g., type 2 LBT). The WTRU may determine one or more CCA/LBT parameters based on the reception/monitoring status in the PSFCH period. In examples, the WTRU may determine one or more CCA/LBT parameters if the WTRU receives the PSFCH. If the WTRU decodes the HARQ feedback (e.g., HARQ ACK/NACK) from the Rx WTRU, the WTRU may acquire the channel without performing CCA/LBT or the WTRU may acquire the channel for a fixed duration (e.g., LBT type 2A or 2B). If the WTRU detects DTX (e.g., no feedback from the Rx WTRU) or if the WTRU does not detect a transmission (e.g., any transmission) in the PSFCH symbols, the WTRU may acquire the channel using another type of LBT (e.g., type 1 LBT). In examples, the WTRU may determine one or more CCA/LBT parameters if the WTRU does not receive the PSFCH. The WTRU may perform one type of LBT (e.g., type 2 LBT) after the PSFCH symbols. The WTRU may determine the CCA/LBT type based on the detected energy in the PSFCH symbols. The WTRU may perform one type of LBT (e.g., type 1 LBT) if the detected energy in PSFCH symbols are smaller than a threshold; otherwise, the WTRU may perform another type of CCA/LBT (e.g., type 2 LBT).

The WTRU may be (pre)configured with a mapping of one PSCCH/PSSCH to multiple PSFCH occasions. The WTRU may be (pre)configured with a resource pool, in which a PSCCH/PSSCH resource (e.g., each PSCCH/PSSCH resource) has multiple associated PSFCH occasions (e.g., two PSFCH occasions may be mapped to one PSCCH/PSSCH resource). Based on reception of a PSCCH/PSSCH, the Rx WTRU may perform (e.g., sequentially perform) CCA/LBT to access a PSFCH occasion (e.g., each PSFCH occasion) to transmit HARQ ACK/NACK feedback to the Tx WTRU. In examples, the WTRU may stop performing CCA/LBT in the remaining occasions if it successfully transmits HARQ ACK/NACK feedback in an occasion (e.g., one occasion). The WTRU may perform CCA/LBT in multiple associated PSFCH occasions (e.g., all the associated PSFCH occasions). The WTRU may perform HARQ ACK/NACK feedback in multiple PSFCH occasions. The WTRU may determine occasion(s) in which to perform CCA/LBT and transmission of HARQ feedback (e.g., in one or multiple PSFCH occasions and/or in which occasion(s)) based on one or more of the following. The WTRU may determine occasion(s) in which to perform CCA/LBT and transmission of HARQ feedback based on a (pre) configuration in the resource pool. For example, the WTRU may be (pre)configured in the resource pool with information related to whether to feedback one or multiple times for one PSCCH/PSSCH if a PSSCH/PSSCH has multiple associated PSFCH occasions. The WTRU may perform HARQ feedback transmission based on the (pre) configuration in the resource pool. The WTRU may determine occasion(s) in which to perform CCA/LBT and transmission of HARQ feedback based on an indication from the Tx WTRU. For example, the WTRU may determine whether to perform feedback in one or multiple associated PSFCH occasions of the PSCCH/PSSCH based on the indication from the Tx WTRU. The Tx WTRU may indicate to the Tx WTRU (e.g., in the second SCI) whether it expects the Rx WTRU to feedback in one or multiple PSFCH occasions. For example, the Tx WTRU may indicate (e.g., in the SCI) whether the Tx WTRU is expecting HARQ feedback in the indicated occasion or in a (pre)configured occasion. The Rx WTRU may determine whether to transmit HARQ ACK/NACK as indicated by the Tx WTRU. For example, if the Tx WTRU does not indicate the HARQ feedback occasion, the Rx WTRU may transmit HARQ ACK/NACK in one or more (pre)configured HARQ feedback occasions in the resource pool associated with the PSCCH/PSSCH. Otherwise, if the Tx WTRU indicates the HARQ ACK/NACK feedback occasion, the Rx WTRU may perform HARQ ACK/NACK feedback on the indicated occasion(s). The WTRU may determine occasion(s) in which to perform CCA/LBT and transmission of HARQ feedback based on HARQ feedback type (e.g., whether the HARQ feedback type is HARQ feedback option 1 or option 2). For example, the WTRU may feedback once for unicast/groupcast option 2. The WTRU may feedback multiple times for groupcast option 1. The WTRU may determine occasion(s) in which to perform CCA/LBT and transmission of HARQ feedback based on the HARQ information that the WTRU intends to feedback (e.g., whether the WTRU plans to report HARQ ACK or HARQ NACK). For example, the WTRU may perform one HARQ feedback transmission if the WTRU feeds back HARQ ACK to indicate the successful decoding of the TB. In examples, if the WTRU feeds back HARQ NACK to indicate the unsuccessful decoding of the TB, the WTRU may feedback multiple times (e.g., in multiple (pre)configured/indicated PSFCH occasions associated to the PSCCH/PSSCH resource). The WTRU may determine occasion(s) in which to perform CCA/LBT and transmission of HARQ feedback based on QoS of the TB. For example, the WTRU may perform one HARQ feedback transmission if the QoS of the TB is smaller than a threshold; otherwise, if the QoS of the TB is larger than the threshold, the WTRU may feedback multiple times (e.g., in multiple (pre)configured/indicated PSFCH occasions associated to the PSCCH/PSSCH resource). The QoS threshold may be (pre)configured in the resource pool or (pre)configured in the service.

A synchronization procedure may be performed. A WTRU may transmit an SSB in a (pre)configured resource. A WTRU may (e.g., determine to) be a synchronization reference WTRU. The WTRU may (e.g., then determine to) perform an S-SSB transmission. The WTRU may (e.g., determine to) transmit an S-SSB in one or more (pre)configured resources for S-SSB.

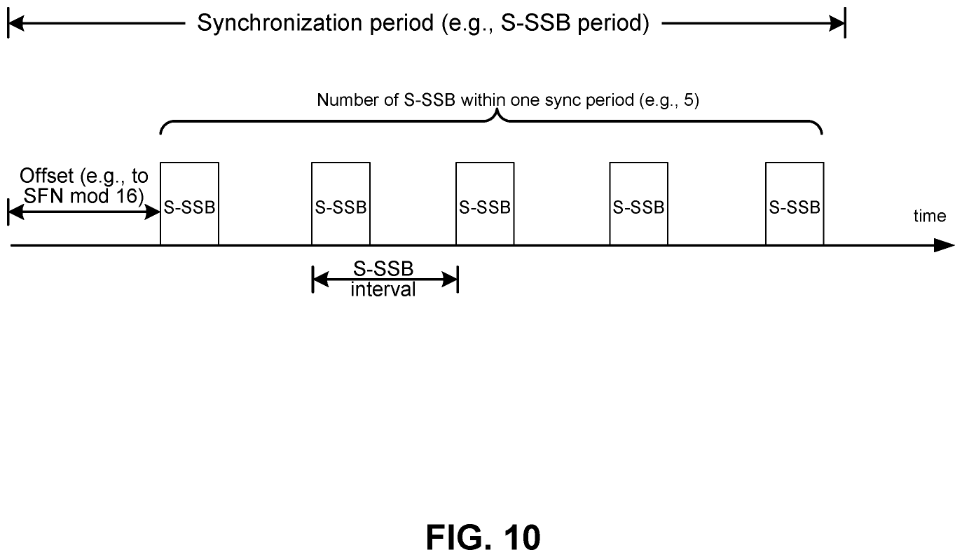

FIG. 10 illustrates an example of a (pre)configured resource for an S-SSB transmission. As shown by example in FIG. 10, a WTRU may be (pre)configured with N resources for an S-SSB transmission.

A WTRU may determine whether to perform CCA before a (pre)configured resource for an S-SSB transmission. A WTRU may determine whether to perform CCA before a (pre)configured resource for an S-SSB transmission, for example, based on the availability of other WTRU's transmission in the slot before the slot (pre)configured for S-SSB transmission. The WTRU may perform an S-SSB transmission without CCA, for example, if the WTRU detects another WTRU in the system transmitting in the slot. The WTRU may perform CCA before the (pre)configured resource for an S-SSB transmission, for example, if the WTRU does not detect another WTRU in the system transmitting in the slot. The WTRU may perform an S-SSB transmission, for example, if the channel is clear. The WTRU may refrain from transmitting S-SSB in the resource, for example, if the channel is not clear. A WTRU may determine the number of S-SSB transmissions in a synchronization period. In some examples, a WTRU may be (pre)configured with a minimum and/or a maximum number of S-SSB transmissions within a synchronization period (e.g., 160 ms). The WTRU may perform a CCA before a (e.g., each) (pre)configured resource for an S-SSB transmission. A CCA duration may be set to be zero, for example, if the WTRU is not required to perform a CCA before the S-SSB resource. The WTRU may perform an S-SSB transmission in the resource, for example, if the channel is clear. The WTRU may determine (e.g., for each configured resource for S-SSB transmission) whether to perform a CCA and/or an S-SSB transmission, for example, based on the number of S-SSBs the WTRU has transmitted in the synchronization period. The WTRU may not perform a CCA and/or an S-SSB transmission, for example, if the number of S-SSBs transmitted in the synchronization period is larger than the maximum threshold. The WTRU may perform a CCA and/or an S-SSB transmission in the (pre)configured resource for S-SSB transmission, for example, if the number of S-SSBs transmitted within the synchronization period is smaller than the minimum threshold. A WTRU may pause the WTRU's COT for another transmission. In some examples, a WTRU may occupy a (e.g., one) COT (e.g., one COT and/or FFP), which may have one or more resources (pre)configured for other transmissions (e.g., S-SSB transmission). The WTRU may stop performing transmission in the (pre)configured resources. The WTRU may rate-match and/or puncture a portion of a resource (e.g., one or more orthogonal frequency-division multiplexing (OFDM) symbols) in the transmission of the slot before the slot (pre)configured for an S-SSB transmission. Rate-matching and/or puncturing a portion of a resource may allow the Tx WTRU of the S-SSB to clear the channel when it performs a CCA. A WTRU may resume the WTRU's COT after a (pre)configured resource. A WTRU (e.g., after pausing the WTRU's COT for another WTRU's transmission) may resume a transmission after the (pre)configured resource. In some examples, the WTRU may not perform a CCA before the resumed resource. In some examples, the WTRU may perform a CCA to clear a channel before the resumed resource. The WTRU may perform a transmission, for example, if the channel is clear. The WTRU may wait until the next COT and/or FFP to perform a CCA to access the channel, for example, if the channel is not clear.

The WTRU may determine one or more CCA/LBT parameters (e.g., CCA/LBT duration including no CCA/LBT, fixed CCA/LBT duration, and/or flexible CCA/LBT duration) to perform CCA/LBT based on one or more of the following. The WTRU may determine one or more CCA/LBT parameters based on a (pre) configuration. For example, the WTRU may be (pre)configured to perform one type of CCA/LBT (e.g., type 2 LBT) after the S-SSB slot. The WTRU may perform CCA/LBT after the S-SSB to resume its transmission. The WTRU may determine one or more CCA/LBT parameters based on the QoS associated with its data. For example, the WTRU may perform a fixed LBT/CCA duration if QoS of the TB is smaller than a threshold; otherwise, the WTRU may perform flexible LBT/CCA duration (e.g., type 1 LBT) if the QoS of the TB is larger than a threshold. The WTRU may determine one or more CCA/LBT parameters based on one or more CCA/LBT parameters used to acquire the COT/FFP. For example, the WTRU may not perform LBT/CCA if the WTRU uses type 1 LBT to acquire the COT/FFP. Otherwise, if the WTRU shares the COT/FFP of another WTRU, the WTRU may use type 2 LBT (e.g., type 2A or type 2B) to sense the channel after the pause duration. The WTRU may determine one or more CCA/LBT parameters based on the CBR of the resource pool. The WTRU may use one type of LBT/CCA if CBR is smaller than a threshold (e.g., type 1 LBT). Otherwise, the WTRU may use another type of LBT/CCA (e.g., type 2 LBT). The WTRU may determine based on the reception/monitoring status in the S-SSB slot. The WTRU may monitor S-SSB slot. The WTRU may determine one or more CCA/LBT parameters based on the reception/monitoring status of the WTRU. In examples, the WTRU may determine the CCA/LBT type based on the energy detected in the S-SSB slot. If the detected energy in the S-SSB is greater than a threshold, the WTRU may perform one type of CCA/LBT (e.g., type 2 LBT); otherwise, if the detected energy in the S-SSB is smaller than a threshold, the WTRU may perform another type of CCA/LBT (e.g., type 1 LBT). In examples, the WTRU may detect an S-SSB signal (e.g., a sidelink secondary synchronization signal (S-SSS), sidelink primary synchronization signal (S-PSS), and/or sidelink synchronization signal (SLSS)) in the slot. If S-SSB is detected, the WTRU may perform one type of CCA/LBT (e.g., type 2 LBT); otherwise, if S-SSB is not detected, the WTRU may perform another type of CCA/LBT (e.g., type 1 LBT).

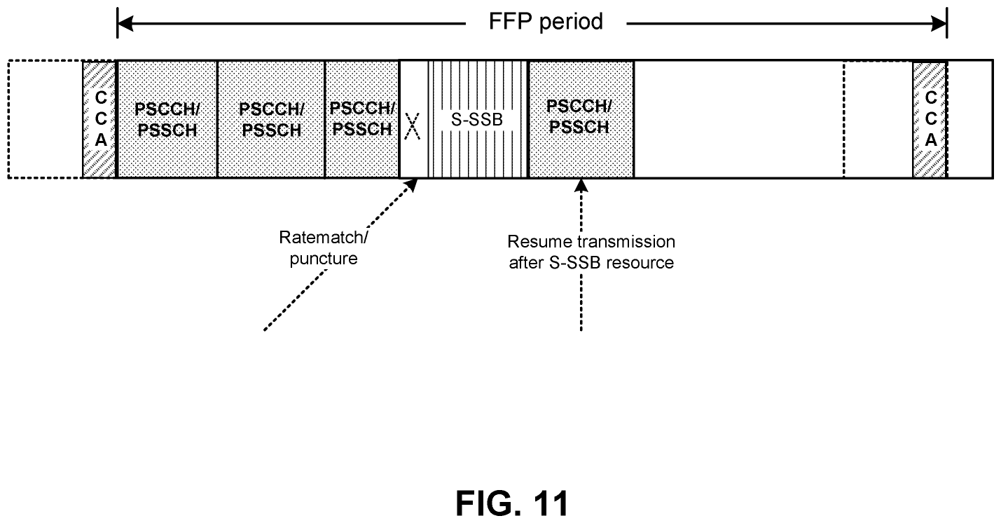

FIG. 11 illustrates an example of a WTRU pausing a transmission for an S-SSB and resuming the transmission afterward. As illustrated in FIG. 11, a WTRU may acquire a COT (e.g., a COT and/or FFP), in which there is a (e.g., one) (pre)configured resource for an S-SSB transmission. The WTRU may (e.g., first) puncture/rate-match one or more OFDM symbols for other WTRUs to perform CCA in the slot before the (pre)configured resource for an S-SSB transmission. The WTRU may (e.g., also) stop a transmission in the slot. The WTRU may resume the transmission (e.g., from the slot) after the (pre)configured resource for the S-SSB transmission.

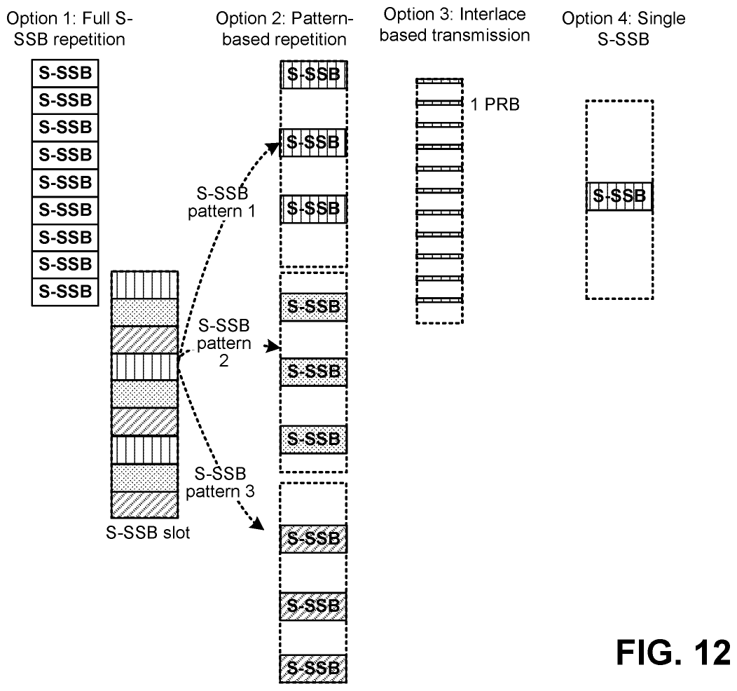

FIG. 12 shows an example of a WTRU determining S-SSB pattern(s) to transmit. The WTRU may be (pre)configured with multiple types of resources for S-SSB transmission/reception. The WTRU may be (pre)configured with one or more types of S-SSB slots for S-SSB transmission/reception in a carrier, slidelink bandwidth part (SL-BWP), and/or resource pool. The first type of slot may be SL-BWP and/or carrier specific. The WTRU may not use this (pre)configured slot for a transmission (e.g., any transmission) other than S-SSB. The second type of slot may be (pre)configured in the resource pool. The WTRU may use this slot for other transmission(s) such as PSCCH/PSSCH and/or PSFCH. The WTRU may use the second type of slots for other transmission(s) based on one or more of the following. The WTRU may use the second type based on the detection of one or more S-SSB in the first type of slots in a period. For example, the WTRU may use the second type of S-SSB slots for other transmission if the WTRU detects one or more S-SSBs transmitted in the first type of S-SSB slot. Otherwise, the WTRU may not perform other transmission in the second type of slot. The number of detected S-SSB to be able to transmit in the second type of S-SSB slots in a period may be fixed (e.g., 1 S-SSB) or (pre)configured in the carrier. The WTRU may use the second type based on the energy detection in one or more S-SSB(s) in the first type of slots in a period. For example, the WTRU may use the second type of S-SSB slots for other transmission(s) if the WTRU detects one or more S-SSB transmitted in the first type of S-SSB slot. Otherwise, the WTRU may not perform other transmission(s) in the second type of slot. The WTRU may use the second type based on the QoS of the TB. For example, the WTRU may use the second type of S-SSB slots for other transmission(s) if the QoS of the TB is greater than a threshold; otherwise, the WTRU may not use the second type of S-SSB slots for other transmission(s). The WTRU may use the second type based on one or more parameters to acquire the channel. For example, the WTRU may use the second type of S-SSB slots for other transmission(s) if the CAPC to acquire the channel is larger than a threshold; otherwise, the WTRU may not use the second type of S-SSB slots for other transmission(s). The WTRU may use the second type based on the CBR of the resource pool. For example, the WTRU may use the second type of S-SSB slots for other transmission(s) if CBR of the resource pool satisfies a (pre)configured condition (e.g., CBR is larger than a threshold). Otherwise, if the CBR of the resource pool does not satisfy the (pre)configured condition, the WTRU may not use the second type of S-SSB slots for other transmission(s).

The WTRU may perform S-SSB transmission in the (pre)configured S-SSB slot in a resource pool. In examples, the WTRU may determine to transmit S-SSB to become a synchronization reference WTRU (e.g., SyncRefUE). The WTRU may be (pre)configured with two types of S-SSB slots, in which the first type of slot may be dedicated for S-SSB and the second type of S-SSB slots may be shared with other transmission(s). Before one second type of S-SSB slots, the WTRU may determine whether to transmit S-SSB based on one or more of the following. The WTRU may determine whether to transmit S-SSB based on the number of S-SSB transmissions (e.g., the S-SSB transmissions in the first type of slots and/or the S-SSB transmissions in the second type of slots) that the WTRU has made before during a synchronization period. For example, the WTRU may perform CCA/LBT to transmit in the S-SSB slot if the number of S-SSB transmissions that the WTRU has made before during the synchronization period is smaller than a threshold; otherwise, the WTRU may not transmit S-SSB in the slot. The threshold may be (pre)configured in the resource pool, SL-BWP, and/or carrier. The WTRU may determine whether to transmit S-SSB based on whether the WTRU acquires the COT/FFP before the S-SSB slot. For example, the WTRU may prioritize transmitting S-SSB in the S-SSB slot if the WTRU acquires the COT/FFP for data transmission in one or more slots before the (pre)configured S-SSB slots. Otherwise, the WTRU may not transmit S-SSB. The WTRU may determine whether to transmit S-SSB based on QoS of the data. For example, the WTRU may acquire the COT/FFP. The WTRU may determine whether to prioritize S-SSB or data transmission in the COT/FFP based on the QoS of the data. If the QoS of the data is larger than a threshold, the WTRU may prioritize data transmission. Otherwise, the WTRU may prioritize S-SSB transmission. The WTRU may determine whether to transmit S-SSB based on the CBR of the resource pool. For example, the WTRU may determine whether to transmit in the second type of S-SSB slot based on CBR of the resource pool. If the CBR of the resource pool satisfies a (pre)configured condition (e.g., CBR is smaller than a threshold), the WTRU may perform S-SSB transmission. Otherwise, if CBR of the resource pool does not satisfy the (pre)configured condition, the WTRU may not perform S-SSB transmission in the second type of S-SSB slot. The CBR threshold may be (pre)configured in the resource pool. The WTRU may determine whether to transmit S-SSB based on the priority associated with the sync source. For example, the WTRU may determine whether to transmit in the second type of S-SSB slot based on the priority of the sync source. If the priority of the sync source is larger than a threshold, the WTRU may perform S-SSB transmission. Otherwise, if the priority of the sync source is smaller than the threshold, the WTRU may not perform S-SSB transmission in the second type of S-SSB slot. The sync source threshold may be (pre)configured in the resource pool. The WTRU may determine whether to transmit S-SSB based on coverage status. For example, the WTRU may determine whether to transmit in the second type of S-SSB slot based on its coverage status. If the WTRU is in coverage, the WTRU may perform S-SSB transmission. Otherwise, the WTRU may not perform S-SSB transmission in the second type of S-SSB slot.

The WTRU may be (pre)configured with types of S-SSB transmission. The WTRU may be (pre)configured with one or more of the following types of S-SSB transmissions, which may be described with respect to FIG. 12. In the first option (e.g., option 1): the WTRU may be (pre)configured to perform repetition of S-SSB in the whole LBT sub-band. In the second option (e.g., option 2), the WTRU may be (pre)configured multiple S-SSB repetitions. The WTRU may select one S-SSB repetition pattern to transmit. In the third option (e.g., option 3), the WTRU may be (pre)configured to transmit S-SSB using the interlace-based transmission. In the fourth option (e.g., option 4), the WTRU may transmit an S-SSB in a bandwidth.

The WTRU may determine an S-SSB option and/or S-SSB pattern to transmit. The WTRU may determine an S-SSB transmission option (e.g., option 1, 2, 3, or 4) to select. If option 2 or 3 is selected, the WTRU may determine an S-SSB pattern (e.g., S-SSB repetition and/or S-SSB interlace index) to select. The WTRU may determine an S-SSB transmission and/or S-SSB pattern to transmit based on one or more of the following. The WTRU may determine the S-SSB transmission and/or S-SSB pattern to transmit based on a (pre) configuration in the carrier and/or resource pool. The WTRU may determine the S-SSB transmission and/or S-SSB pattern to transmit based on a type of S-SSB slot. For example, the WTRU may be (pre)configured with types (e.g., two types) of S-SSB slots, in which the first type of S-SSB slot may be dedicated for S-SSB transmission and the second type of S-SSB slots may be shared with other transmission(s). The WTRU may determine which S-SSB transmission and/or S-SSB pattern to select based on the type of S-SSB slot. In examples, the WTRU may be (pre)configured with two different types of S-SSB transmissions, in which the first type of S-SSB transmission may be associated with the first type of S-SSB slot (e.g., option 4, which may not require OCB) and the second type of S-SSB transmission may be associated with the second type of S-SSB slot (e.g., option 2, which may require OCB). The WTRU may determine which type of S-SSB transmission based on the type of S-SSB slot. The WTRU may determine the S-SSB pattern based on the WTRU ID. For example, the WTRU may select the S-SSB pattern based on its ID. The WTRU may determine the S-SSB pattern based on a sidelink synchronization signal identifier (SLSSID). For example, the WTRU may select the S-SSB pattern based on its ID. The WTRU may determine the S-SSB pattern based on a synchronization priority. For example, the WTRU may select the S-SSB pattern based on its ID. The WTRU may determine the S-SSB pattern based on coverage status. For example, the WTRU may select the S-SSB pattern based on its ID.

A WTRU may be (pre)configured with multiple types of S-SSB resources. The S-SSB resources (e.g., each type of S-SSB resources) may be determined based on one or more of the following: the priority associated with S-SSB transmission(s); whether the S-SSB resource(s) can be used for other transmission(s) (e.g., data transmission(s) or feedback); or prioritized access and transmission of an S-SSB.

For the priority associated with S-SSB transmission(s), the priority of S-SSB(s) may be associated with the synchronization source of the WTRU (e.g., whether the synchronization source is a global navigation satellite system (GNSS), a gNB, an in coverage WTRU, an out of coverage WTRU, etc.). The priority of S-SSB resource(s) may refer to the (pre)configured synchronization source (e.g., synchronization priority level) of the synchronization transmission WTRU.

For whether the S-SSB resource(s) can be used for other transmission(s) (e.g., data transmission(s) or feedback), the WTRU may be (pre)configured with two types of S-SSB resources, in which a first type of S-SSB resource(s) may be shared with the other sidelink transmission (e.g., data, PSFCH) and a second type of S-SSB resource(s) may not be shared with the other sidelink transmission (e.g., this resource may be used for S-SSB transmission(s) only).

For prioritized access and transmission of an S-SSB, the WTRU may be (pre)configured with two types of S-SSB resources. The WTRU may prioritize accessing the channel and transmitting an S-SSB in one or more resource(s) associated with a first type. The WTRU may access the channel and transmit an S-SSB in one or more resource(s) associated with a second type if the WTRU cannot access the channel and transmit the S-SSB in one or resources(s) associated with the first type. For example, the WTRU may access the channel and transmit an S-SSB in one or more resource(s) associated with a second type if it cannot access the channel and transmit the S-SSB in N resources associated with the first type. The value of N may be fixed (e.g., fixed as one) and/or (pre)configured. The value of N may be determined (e.g., further determined) based on the number of (pre)configured S-SSB resource(s) associated with the first type.

A WTRU may determine a type of S-SSB resource(s) to use to transmit an S-SSB. The WTRU may be (pre)configured with multiple sets of S-SSB resource(s), in which the sets of S-SSB resource(s) (e.g., each set of S-SSB resource(s)) may be associated with one S-SSB resource priority (e.g., based on the synchronization source of the S-SSB). The WTRU may (e.g., may then) determine a set of S-SSB resource(s) to use to transmit an S-SSB based on the priority of the S-SSB and the priority associated with the S-SSB resource(s). In examples, the WTRU may transmit an S-SSB in an S-SSB occasion having the same priority. In examples, the WTRU may transmit an S-SSB in S-SSB occasion(s) having the same or lower priority than the priority of the transmitting S-SSB.

A WTRU may determine the LBT parameters for S-SSB occasion(s) (e.g., each type of S-SSB occasion) and S-SSB transmission(s). In examples, the WTRU may determine the LBT parameters to use to transmit an S-SSB in S-SSB occasion(s) (e.g., each (pre)configured S-SSB occasion). The WTRU may (e.g., may then) determine the value of one or more LBT parameters (e.g., LBT type for one LBT sub-band channel access (e.g., LBT type 1, 2, 2A, 2B, 2C)), the channel access priority class (CAPC), the contention window size, which may include the current contention window (CWₚ), the minimum, and/or the maximum contention window associated with the channel access priority class p (e.g., CWₚ, CW_{min,p}, and CW_{max,p}), the current value or the initial value of the backoff counter (N), the COT duration, which may include the current COT and/or the maximum COT, the defer period (T a), the LBT energy detection threshold used to determine the availability of a channel, the FFP configuration, the Clear Channel Access (CCA) duration, the channel access time in each slot, and/or the Cyclic Prefix Extension (CPE) duration to use based on one or more of the following: the type associated with S-SSB occasion(s); the priority associated with S-SSB transmission(s); or the priority associated with S-SSB occasion(s).

For the type associated with S-SSB occasion(s) (e.g., the priority associated with SSB occasion(s), whether S-SSB resource(s) are dedicated for S-SSB transmission(s) or shared with other transmission(s)), the WTRU may be (pre)configured with a CPE duration or a channel access time (e.g., a duration to the slot boundary) for an S-SSB transmission if an S-SSB occasion is shared with other sidelink communication(s) (e.g., data or PSFCH). The WTRU may (e.g., may then) use the (pre)configured CPE duration or channel access time (pre)configured to the transmission of an S-SSB in a shared resource with other sidelink transmission(s).

For the priority associated with S-SSB transmission(s), the WTRU may be (pre)configured with one or more of a channel sensing duration (e.g., CAPC, CCA duration); a channel access time; or a CPE duration to access the channel based on the priority of the S-SSB transmission. The WTRU may (e.g., may then) determine LBT parameters to use (e.g., CAPC, channel sensing time, CPE duration, or channel access time) based on the priority associated with the S-SSB transmission.

For the priority associated with S-SSB occasion(s) (e.g., the lowest or highest synchronization priority allowed to be transmitted in an S-SSB occasion), the WTRU may be (pre)configured with a set of LBT parameters to access SSB occasion(s) (e.g., each S-SSB occasion). The WTRU may (e.g., may then) determine LBT parameters to access the channel based on the accessed S-SSB occasion.

A WTRU may determine whether to transmit data/feedback in S-SSB occasion(s). In examples, the WTRU may be (pre)configured with an S-SSB occasion, which may allow other types of transmission(s) to transmit in the resource(s). The WTRU may use the resource(s) to transmit one or more of the following types of transmission(s): sidelink data; or sidelink feedback.

For sidelink data transmission(s), the WTRU may be (pre)configured for a certain type of data (e.g., the data with a certain QoS, a cast type, a destination ID, a HARQ type) to transmit in S-SSB occasion(s). The WTRU may (e.g., may then) determine to transmit data in S-SSB occasion(s) if the data satisfies the (pre)configured condition. For example, the WTRU may transmit data in S-SSB occasion(s) if the priority of the data is greater than a threshold. Otherwise, the WTRU may not transmit data in S-SSB occasion(s).

For sidelink data transmission(s), the WTRU may be (pre)configured with a set of LBT parameters to transmit in S-SSB occasion(s). The WTRU may use the (pre)configured LBT parameters to access the channel. In examples, the WTRU may be (pre)configured with a CAPC, channel access time and/or a CPE duration to access the channel. The WTRU may (e.g., may then) use the (pre)configured channel access time and/or the CPE duration to access the channel and transmit data.

For sidelink feedback transmission(s), the WTRU may be allowed to send a PSFCH transmission if the transmission is in an S-SSB occasion. For sidelink feedback transmission(s), the WTRU may be allowed to transmit a PSFCH in an S-SSB occasion if the QoS of the data associated with the feedback is greater than a (pre)configured threshold.

A WTRU may transmit in the second type of S-SSB resource if failure occurs in the first type of S-SSB resource. The WTRU may be (pre)configured with two types of S-SSB resources. One or more S-SSB resources in the first type may have one or more associated S-SSB resources in the second type. The WTRU may try to access the channel to transmit an S-SSB in one or more resource(s) associated with the first type. The WTRU may (e.g., may then) determine whether to perform LBT and transmit S-SSB(s) in one or more S-SSB resource(s) associated with the second type based on whether the WTRU successfully transmitted an S-SSB in one or more SSB resource(s) associated with the first type. In examples, the WTRU may transmit an S-SSB in one or more resource(s) associated with the second type if the WTRU fails to transmit in one or more S-SSB resource(s) associated with the first type. Otherwise, if the WTRU successfully transmits in one or more S-SSB resource(s) associated with the first type, the WTRU may not transmit an S-SSB in one or more S-SSB resource(s) associated with the second type.

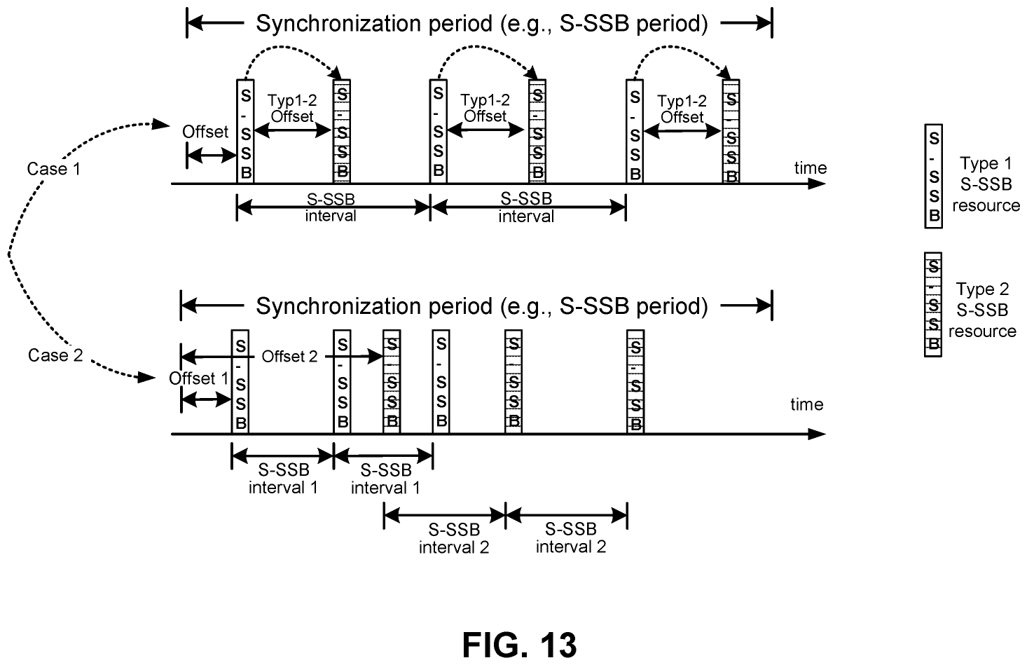

FIG. 13 illustrates an example of a configuration with multiple types of S-SSB resources. For example (e.g., as shown in case 1 in FIG. 13), the WTRU may be (pre)configured with one or more resource(s) associated with a second type (e.g., type 2 S-SSB resource in FIG. 13) per each set of one or more resource(s) associated with a first type (e.g., type 1 S-SSB resource in FIG. 13). The WTRU may (e.g., may then) determine to transmit an S-SSB in one or more resource(s) associated with the second type if the WTRU fails to transmit the S-SSB in one or more resource(s) associated with the first type. The WTRU may access the channel and transmit data and/or feedback in one or more S-SSB resource(s) associated with the second type if the WTRU successfully transmits in one or more S-SSB resource(s) associated with the first type. Other WTRU(s), if detecting one or more S-SSB transmission(s) in one or more resource(s) associated with the first type, may access the channel and transmit (e.g., data or PSFCH) one or more S-SSB(s) in one or more resource(s) associated with the second type.

For example (e.g., as shown in case 2 of FIG. 13), the WTRU may be (pre)configured with two independent sets of S-SSB resources (e.g., type 1 and type 2 S-SSB resources). The WTRU may (e.g., may then) be (pre)configured with the maximum and/or the minimum number of S-SSB transmissions in a synchronization period. The WTRU may (e.g., may then) sequentially access the channel for transmission in SSB occasion(s) (e.g., each S-SSB occasion) from both types of S-SSB occasions. The WTRU may (e.g., may then) stop transmitting an S-SSB in one period if the number of S-SSB transmission(s) is greater than the maximum (pre)configured threshold. The WTRU may continue performing S-SSB transmission(s) in the period if the number of S-SSB transmission(s) in the period is smaller than the minimum (pre)configured threshold. The WTRU may access and transmit in the remaining S-SSB occasion(s) in a synchronization period if the WTRU successfully transmits at least the minimum number of (pre)configured S-SSB(s). In examples, if detecting at least a (pre)configured number of S-SSB transmission(s) in a synchronization period, the WTRU may access the channel and transmit (e.g., data or PSFCH) in the remaining S-SSB occasion(s).

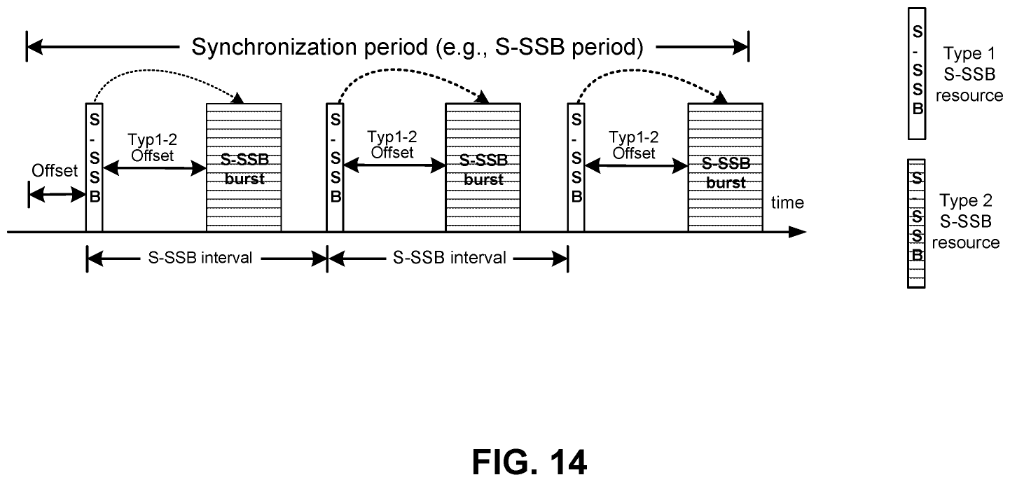

FIG. 14 illustrates an example of a configuration of multiple types of S-SSB resource(s) for an S-SSB burst case. For example (e.g., as shown in FIG. 14), the WTRU may be (pre)configured with two types of S-SSB resources. One or more S-SSB resource(s) may be associated with a first type and one or more S-SSB resource(s) may be associated with a second type. The second type may be an S-SSB burst, which may follow the S-SSB resource(s) associated with the first type. The WTRU may (e.g., may then) determine to transmit an S-SSB in one or more S-SSB resource(s) associated with the second type if the WTRU fails to transmit in one or more S-SSB resource(s) associated with the first type. The WTRU may access the channel and transmit data and/or feedback in one or more S-SSB resource(s) associated with the second type of S-SSB if the WTRU successfully transmits in one or more S-SSB resource(s) associated with the first type. Other WTRUs, if detecting one or more S-SSB transmission(s) in one or more S-SSB resource(s) associated with the first type, may access the channel and transmit (e.g., data or PSFCH) in one or more S-SSB resource(s) associated with the second type.

A WTRU may determine whether to continue using a COT for data and/or feedback upon transmission of an S-SSB. In examples, the WTRU may transmit data and/or feedback if transmitting an S-SSB in an S-SSB burst. The WTRU may determine whether to continue using the COT for data and/or feedback if transmitting an S-SSB in an S-SSB burst based on one or more of the following: the LBT parameters used to acquire the COT; QoS of the data; or QoS of the data associated with the feedback.

For the LBT parameters used to acquire the COT, if the WTRU uses type 1 LBT to acquire the COT, the WTRU may continue using the COT for data and/or feedback transmission after transmitting an S-SSB. If the WTRU uses type 2 LBT, the WTRU may not continue using the COT for data and/or feedback transmission.

For QoS of the data, the WTRU may continue using the COT for data transmission after transmitting an S-SSB if the priority of the TB is smaller than a threshold. Otherwise, the WTRU may not continue using the COT.

For QoS of the data associated with the feedback, the WTRU may continue using the COT for feedback transmission after transmitting an S-SSB if the priority of the associated TB is smaller than a threshold. Otherwise, the WTRU may not continue using the COT.

A WTRU may determine a burst of S-SSBs to use to transmit based on the priority of a Tx S-SSB and/or S-SSB burst. The WTRU may be (pre)configured with multiple bursts of S-SSB resources in synchronization periods. The WTRU may determine an S-SSB burst in which to transmit an S-SSB based on the priority associated with the S-SSB burst and/or the priority associated with the transmitting S-SSB. In examples, the WTRU may transmit the S-SSB in a burst if the (pre)configured priority of the S-SSB burst is equal to the priority of the transmitted S-SSB. In examples, the WTRU may transmit an S-SSB in the burst if the priority of the S-SSB burst is smaller than or equal to the priority of the S-SSB.

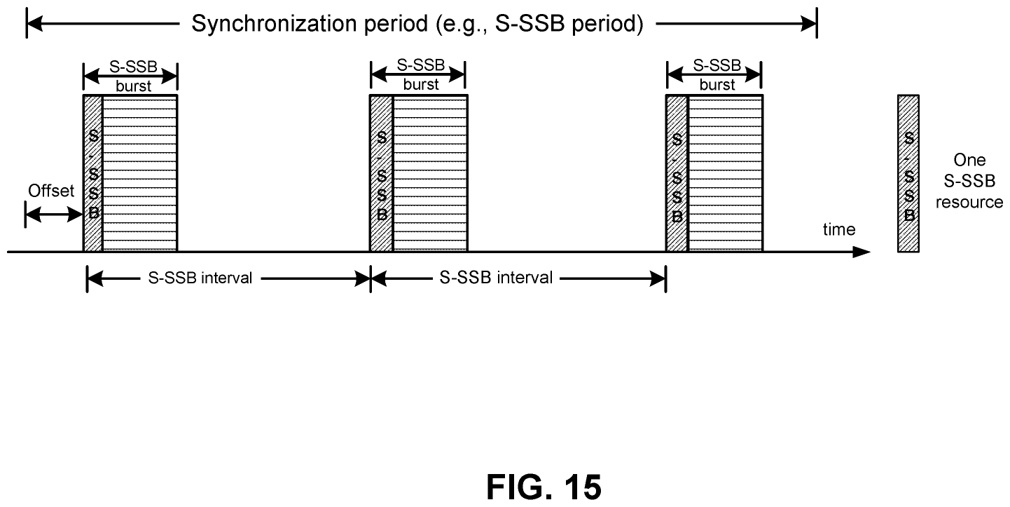

FIG. 15 illustrates an example of a configuration (e.g., for a WTRU) for a burst of S-SSB occasions per synchronization period. For example (e.g., as shown in FIG. 15), the WTRU may be (pre)configured with one or more S-SSB bursts in a synchronization period. The WTRU may (e.g., may then) be (pre)configured to transmit a minimum and/or maximum number of S-SSB(s) in a burst. If transmitting the minimum and/or maximum (pre)configured number of S-SSB(s) in an S-SSB burst, the WTRU may perform data and/or feedback transmission(s) in the remaining occasion(s) of the S-SSB burst. In examples, if detecting a (pre)configured number of S-SSB(s), the WTRU may perform LBT and acquire the channel for data and/or feedback transmission.

A WTRU may acquire a channel and transmit data before S-SSB occasion(s). The WTRU may perform LBT (e.g., type 1 LBT) and acquire the channel before one or more (pre)configured S-SSB occasion(s). The WTRU may perform LBT and acquire the COT for data transmission(s). The WTRU may (e.g., may then) transmit an S-SSB in a (pre)configured S-SSB occasion using a set of LBT parameters, which may be different than the WTRU not acquiring the COT before transmitting an S-SSB. The set of LBT parameters may be (pre)configured/(pre) defined if the WTRU uses the COT-initialized for data transmission(s) to transmit an S-SSB. In examples, the WTRU may not perform LBT (e.g., type 2C) or it may perform LBT with a shorter duration compared to the COT not being acquired before S-SSB transmission(s). The WTRU may (e.g., may then) resume using the COT for subsequent data and/or feedback transmission(s) if transmitting an S-SSB.

A WTRU may determine whether to use the data COT to transmit an S-SSB within the COT. In examples, the WTRU may determine whether to transmit an S-SSB in a (pre)configured S-SSB occasion within the data COT based on one or more of the following: the priority of S-SSB transmission(s); or the priority associated with the (pre)configured S-SSB occasion(s).

For the priority of S-SSB transmission(s), if the priority of the transmitting S-SSB is larger than a threshold, the WTRU may transmit an S-SSB in the acquired COT for data transmission(s). If the priority of the transmitting S-SSB is smaller than a threshold, the WTRU may stop the COT. In examples, the WTRU may perform LBT using the (pre)configured LBT parameters to acquire the channel to transmit the S-SSB.

For the priority associated with the (pre)configured S-SSB occasion(s), the WTRU may determine to use the data COT to transmit an S-SSB in the (pre)configured occasion in the data COT if the priority associated with the (pre)configured S-SSB is smaller than a threshold. Otherwise, the WTRU may not use the COT obtained for data to transmit an S-SSB.

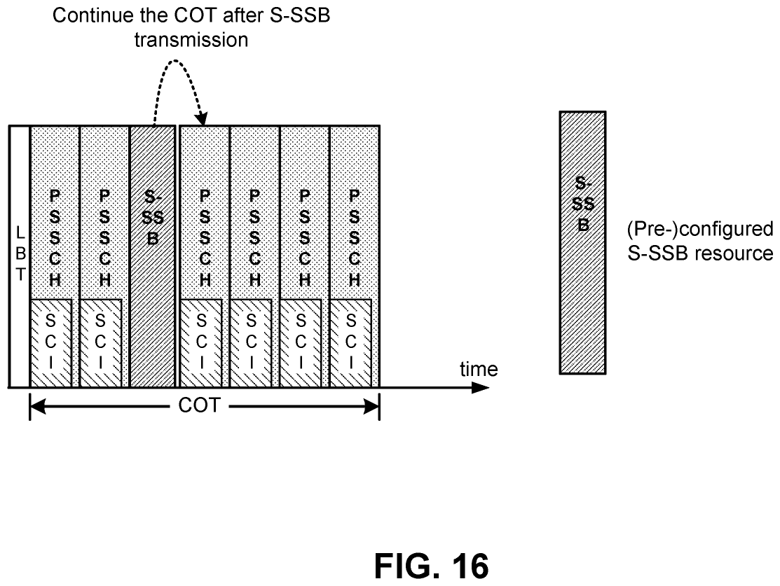

FIG. 16 illustrates an example of a WTRU using the COT obtained for data transmission to transmit an S-SSB. For example (e.g., as shown in FIG. 16), the WTRU may first perform LBT (e.g., type 1 LBT) to acquire the COT to transmit data. The WTRU may transmit an S-SSB in the (pre)configured S-SSB occasion. The WTRU may (e.g., may then) use the COT to transmit data.

A WTRU may acquire a channel in the middle of an S-SSB slot. In examples, the WTRU may acquire the channel in the middle of an S-SSB slot of an S-SSB burst. The WTRU may perform one or more of the following: transmitting a reservation signal (e.g., dummy data); transmitting a mini-slot-based sidelink transmission; or performing defer sensing and resume before the subsequence.

Resources may be allocated. A WTRU may determine whether to initialize a new COT and/or FFP. A WTRU may determine whether to initialize a new COT and/or FFP (e.g., initialize a new COT), for example, based on one or more (e.g., any combination) of the following: an amount of data in the buffer; whether the WTRU has a HARQ to feedback in the WTRU's COT and/or FFP; a QoS of the TB; and/or a CBR of the resource pool.

A WTRU may determine whether to initialize a new COT and/or FFP (e.g., initialize a new COT), for example, based on an amount of data in the buffer. A WTRU may (e.g., determine to) initialize a new COT and/or FFP, for example, if the amount of data in its buffer is greater than a threshold. The WTRU may share the COT with another WTRU, for example, if the amount of data in the WTRU's buffer is less than a threshold.

A WTRU may determine whether to initialize a new COT and/or FFP (e.g., initialize a new COT), for example, based on whether the WTRU has a HARQ to feedback in the WTRU's COT and/or FFP. The WTRU may prioritize initiating a new COT and/or FFP, for example, if the WTRU has pending HARQ feedback to transmit to a Tx WTRU in a COT and/or FFP. The WTRU may share the COT with another WTRU, for example, if the WTRU does not have pending HARQ feedback to transmit to a Tx WTRU in a COT and/or FFP.

A WTRU may determine whether to initialize a new COT and/or FFP, for example, based on a QoS of the TB. A WTRU may initialize a new COT and/or FFP, for example, if the QoS of the TB (e.g., priority, remaining PDB) is smaller than a threshold. The WTRU may not prioritize to initiate a new COT and/or FFP, for example, if the QoS of the TB (e.g., priority, remaining PDB) is larger than (e.g., or equal to) a threshold. The WTRU may initialize a new COT, for example, if the QoS of the TB (e.g., priority, remaining PDB) is larger than a threshold. The WTRU may not prioritize to initiate a new COT and/or FFP, for example, if the QoS of the TB (e.g., priority, remaining PDB) is smaller than (e.g., or equal to) a threshold. In some examples, a WTRU may be (pre)configured with a maximum of N COTs and/or FFPs to access in an observation period. N may be (pre)configured to be consecutive or non-consecutive. N may be a function of the QoS (e.g., priority) of the TB. The WTRU may determine whether to access the new COT and/or FFP, for example, based on the QoS of the TB. The WTRU may access the channel, for example, if the WTRU has not accessed the channel for N COTs and/or FFPs. The WTRU may not access the channel in the current COT and/or FFP, for example, if the WTRU has accessed the channel in N COTs and/or FFPs.

A WTRU may determine whether to initialize a new COT and/or FFP, for example, based on a CBR of the resource pool. A WTRU may initialize a new COT, for example, if the CBR of the resource pool is smaller than a threshold. The WTRU may not initialize (e.g., prioritize initializing) a new COT and/or FFP, for example, if the CBR of the resource pool is greater than (e.g., or equal to) a threshold. The WTRU may initialize a new COT, for example, if the CBR of the resource pool is larger than a threshold. The WTRU may not initialize (e.g., prioritize initializing) a new FFP, for example, if the CBR of the resource pool is smaller than (e.g., or equal to) a threshold.

A WTRU may determine whether to share a COT and/or FFP of another WTRU. In some examples, a WTRU may have a TB to perform resource allocation. The WTRU may determine whether to share a COT and/or FFP of another WTRU, for example, based on one or more (e.g., any combination) of the following: a QoS of the TB (e.g., remaining PDB, priority); a distance to the COT sharing WTRU; a CBR of the resource pool; a channel gain between the WTRU and the COT sharing WTRU; and/or a target receiver of the TB.

A WTRU may determine whether to share a COT and/or FFP of another WTRU, for example, based on a QoS of the TB (e.g., remaining PDB, priority). The WTRU may share the COT and/or FFP, for example, if the priority of the TB is larger than a threshold.

A WTRU may determine whether to share a COT and/or FFP of another WTRU, for example, based on a distance to the COT sharing WTRU. The WTRU may share the COT and/or FFP, for example, if the distance to the COT sharing WTRU is smaller than a threshold. The threshold may be (pre)configured or determined (e.g., based on the minimum communication range (MCR) of the TB).

A WTRU may determine whether to share a COT and/or FFP of another WTRU, for example, based on a CBR of the resource pool. The WTRU may share the COT and/or FFP, for example, if the CBR of the resource pool is smaller than a threshold. The WTRU may share the COT, for example, if the CBR of the resource pool is larger than a threshold.

A WTRU may determine whether to share a COT and/or FFP of another WTRU, for example, based on a channel gain between the WTRU and the COT sharing WTRU. The WTRU may share the COT and/or FFP, for example, if the channel gain between two WTRUs (e.g., sidelink reference signal received power (SL-RSRP) is larger than a threshold.

A WTRU may determine whether to share a COT and/or FFP of another WTRU, for example, based on a target receiver of the TB. The WTRU may share the COT and/or FFP, for example, if the COT sharing WTRU is one of the target receivers.

A WTRU may determine the number of interlaces to select. A WTRU may determine the number of interlaces to select for a (e.g., one) transmission of a TB. The WTRU may be (pre)configured with a maximum number of interlaces to select, for example, based on one or more (e.g., any combination) of the following: a QoS of the TB (e.g., priority); and/or a CBR of the resource pool. The WTRU may select the number of interlaces to satisfy the maximum (pre)configured number of interlaces.

A WTRU may perform resource reservation. A WTRU may (e.g., determine to) reserve one or more (e.g., any combination) of the following (e.g., periodically): an FFP (e.g., the WTRU may determine to reserve an/one FFP every N FFP); a slot in an (e.g., one) FFP; and/or one or more interlaces in an FFP slot of an (e.g., one) FFP.

A WTRU may determine whether to reserve a COT/FFP.

A WTRU may be (pre)configured with one or more restriction(s) to reserve a COT/FFP. The WTRU may be not allowed to reserve a COT/FFP, for example, if one or more restriction(s) are met. The WTRU may be (pre)configured with one or more condition(s) to reserve a COT/FFP. The WTRU may be allowed to reserve a COT/FFP, for example, if one or more condition(s) are met. The WTRU may determine whether to reserve a COT/FFP based on one or more (e.g., any combination) of the following.

The WTRU may determine whether to reserve a COT/FFP based on a QoS of the TB. For example, the WTRU may reserve a COT/FFP if the priority of the data is greater than a (pre)configured threshold; otherwise, the WTRU may not reserve a COT/FFP.

The WTRU may determine whether to reserve a COT/FFP based on a number of transmission resources in a period. For example, the WTRU may reserve a COT/FFP if the number of transmission resources in a COT/FFP is smaller than a (pre)configured threshold; otherwise, the WTRU may not reserve a COT/FFP.

The WTRU may determine whether to reserve a COT/FFP based on an FFP. For example, the WTRU may reserve a COT/FFP if the FFP is smaller than a (pre)configured threshold; otherwise, the WTRU may not be allowed to reserve a COT/FFP.

WTRU may determine whether to reserve a COT/FFP based on a (pre) configuration. For example, the WTRU may be (pre)configured with a maximum number of resources to reserve in a window. For example, the WTRU may be (pre)configured with a maximum number of FFPs to reserve within a window. The WTRU may determine whether to reserve a COT/FFP based on, for example, whether the maximum (pre)configured number of reserved resources and/or the maximum number of reserved COTs/FFPs in a window is reached.

A WTRU may determine the CPE of the WTRU's transmission based on reservation information in a reserved resource.

A WTRU may be (pre)configured with multiple CPEs to access the channel. One or more CPEs (e.g., each CPE) may be associated with one priority. The WTRU may (e.g., determine to) transmit PSCCH/PSSCH in the reserved slot (e.g., using a different set of interlaces) of another WTRU. The WTRU may determine a CPE to use based on one or more (e.g., any combination) of the following.

The WTRU may determine a CPE to use based on a priority associated with the reserved resource. For example, the WTRU may use the CPE associated with the reserved resource as the CPE of the WTRU's transmission. The CPE of the reserved resource may be determined based on the information (e.g., CAPC, priority) indicated in the transmission (e.g., SCI) reserving the resource.

The WTRU may determine a CPE to use based on priority of the WTRU's data transmission.

The WTRU may determine a CPE to use based on a (pre)configured CPE. For example, the WTRU may use a (pre)configured CPE if the WTRU determines to transmit in the same slot(s) with another WTRU (e.g., using a different set of interlaces).

The WTRU may determine a CPE to use based on an indication from another WTRU. For example, the WTRU may receive an indication from the COT initiator WTRU of a CPE to use to perform FDM transmission with one or more reserved slots. The WTRU may use the indicated CPE to access the channel and perform transmission. In another example, another WTRU may reserve a resource for potential transmission in the future. That WTRU may (e.g., implicitly/explicitly) indicate the CPE to use. The WTRU may use the CPE indicated by the resource reserving WTRU.

In examples, the WTRU may (e.g., determine to) transmit in the same slot with another WTRU reserving the slot (e.g., the WTRU may use a different set of interlaces). The WTRU may determine a CPE to use based on a function of the priority of the WTRU's data and/or the priority associated with the reserved slot of the other WTRU. The WTRU may use the CPE associated with the lowest priority of the two priorities. This may guarantee that the high priority reservation may be allowed to access the channel first. The WTRU may use the CPE associated with the highest priority of the two priorities. This may help the WTRU access the channel (e.g., easily access the channel). The WTRU may use the CPE associated with the priority of the reserving WTRU. The WTRU may use the CPE associated with its priority.

The WTRU may (e.g., determine to) transmit in the same slot with another WTRU reserving the slot (e.g., the WTRU may use a different set of interlaces). The slot reserving WTRU may (e.g., implicitly/explicitly) indicate its CPE to access the channel. The WTRU may determine the potential CPE used to access the channel based on the QoS (e.g., CAPC, priority) of its data. The WTRU may determine a CPE to use based on the indicated CPE of the slot reserving WTRU and/or its potential CPE. The WTRU may use the shortest CPE of the two CPEs. The WTRU may use the longest CPE of the two CPEs. The WTRU may use the CPE of the slot reserving WTRU. The WTRU may use its potential CPE.

A WTRU may change its FFP configuration based on resource reservation information.

The WTRU may (e.g., determine to) change its FFP configuration based on a persistent CCA failure in multiple FFPs within an evaluation window. The WTRU may (e.g., determine to) change its FFP configuration based on the detection/reception of FFP configurations from one or more WTRUs, which may result in persistent CCA failure. The WTRU may receive indications from one or more WTRUs regarding their FFP configurations. The WTRU may determine that the FFP configurations of one or more WTRUs may result in persistent CCA failure. The WTRU may request that one or more WTRUs change its FFP configuration. The WTRU may change its FFP configuration. The WTRU may determine whether to change its FFP configuration or request that one or more other WTRUs change their configuration based on one or more (e.g., any combination) of the following.

The WTRU may determine whether to change its FFP configuration or request that one or more other WTRUs change their configuration based on a QoS associated with the WTRU's data. For example, the WTRU may request that another WTRU change its FFP configuration if the QoS associated with the WTRU's data is greater than a (pre)configured threshold; otherwise, the WTRU may change its (e.g., own) FFP configuration.

The WTRU may determine whether to change its FFP configuration or request that one or more other WTRUs change their configuration based on a QoS associated with other WTRU. For example, the WTRU may request that another WTRU change its FFP configuration if the QoS associated with the data of the other WTRU is smaller than a (pre)configured threshold; otherwise, the WTUR may change its (e.g., own) FFP configuration.

The WTRU may determine whether to change its FFP configuration or request that one or more other WTRUs change their configuration based on the relative QoS of the WTRU's data and the other WTRU's data. For example, the WTRU may request that the other WTRU change its FFP configuration if the relative priority between the WTRU's (e.g., own) data and the other WTRU's data is greater than a (pre)configured threshold; otherwise, the WTRU may change its (e.g., own) FFP configuration.

The WTRU may determine whether to change its FFP configuration or request that one or more other WTRUs change their configuration based on one or more parameters of the WTRU's FFP configuration. For example, the WTRU may request that the other WTRU change its FFP configuration if the WTRU's (e.g., own) FFP is greater than a (pre)configured threshold; otherwise, the WTRU may change its (e.g., own) FFP configuration.

The WTRU may determine whether to change its FFP configuration or request that one or more other WTRUs change their configuration based on one or more parameters of FFP configuration of the other WTRUs. For example, the WTRU may request that the other WTRU change its FFP configuration if the FFP of the other WTRU is smaller than a (pre)configured threshold; otherwise, the WTRU may change its (e.g., own) FFP configuration.

The WTRU may determine whether to change its FFP configuration or request that one or more other WTRUs change their configuration based on a latency required for each WTRU to change its FFP configuration. For example, the WTRU may be required to stay in one FFP configuration for a period (e.g., 200 ms). If a (e.g., one) WTRU has changed its FFP configuration recently, the WTRU may take a longer time to change its FFP configuration compared to another WTRU (e.g., which may have changed its FFP configuration a longer time ago). For example, the WTRU may request that another WTRU change its FFP configuration if the latency (e.g., required) for the other WTRU to change the FFP configuration is smaller than the latency to change the FFP configuration of the WTRU (e.g., itself); otherwise, the WTRU may change its (e.g., own) FFP configuration (e.g., itself).

A WTRU may rate-match/puncture a PSCCH/PSSCH before a reserved COT/FFP of another WTRU.

The WTRU may acquire a COT/FFP and transmit PSCCH/PSSCH. The WTRU may detect a reserved COT/FFP within the COT/FFP. The WTRU may (e.g., determine to) share its COT/FFP with another WTRU if the reserved frequency resource (e.g., interlace) is orthogonal with its transmitted frequency resource. The WTRU may rate-match/puncture PSCCH/PSSCH before the reserved COT/FFP of the other WTRU. The rate-match/puncture duration may be determined based on the FFP configuration of the other WTRU. The FFP configuration of the other WTRU may be indicated in the transmission (e.g., SCI, MAC CE) reserving the COT/FFP. This may allow the other WTRU to perform CCA before the reserved FFP.

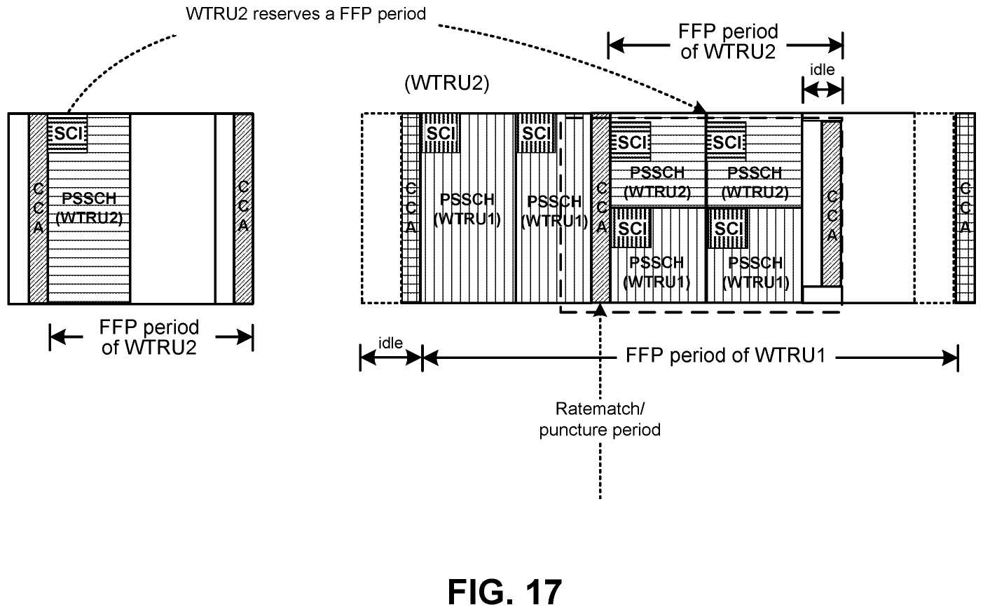

FIG. 17 illustrates a WTRU sharing its COT/FFP with another WTRU. As illustrated in FIG. 17, WTRU1 may initiate its FFP and transmit PSCCH/PSSCH. WTRU1 may detect WTRU2 reserving one COT/FFP, in which the start of the FFP is within the COT/FFP of WTRU1. WTRU1 may decide to share its COT/FFP with WTRU2 by using different frequency resources (e.g., WTRU1 and WTRU2 may use different RB interlaces). WTRU1 may rate-match/puncture a period in the PSCCH/PSSCH transmission before the reserved COT/FFP of WTRU2. If WTRU1 rate-matches/punctures a period, WTRU1 may not transmit (e.g., perform transmission) in that period. WTRU1 may rate-match/puncture in a period (e.g., one period) to support another WTRU performing LBT before the other WTRU's transmission in the following slot. WTRU1 and WTRU2 may share the COT/FFP (e.g., by using different frequency resources for each PSCCH/PSSCH transmission).

A WTRU may determine whether to allow another WTRU to share its COT/FFP.

The WTRU may determine whether to allow another WTRU to share its COT/FFP based on one or more parameters associated with its FFP, the QoS of its data, and/or one or more parameters indicated in the reserved COT/FFP. For example, the WTRU may determine whether to allow another WTRU to share its COT/FFP. The WTRU may indicate whether its COT/FFP may be shared and/or which other WTRU(s) may share (e.g., perform one or more transmissions in) its COT/FFP. The WTRU may be (pre)configured with a rule or condition for determining whether the WTRU's COT/FFP can be shared by other WTRU(s). The rule or condition may be based on a QoS of a transmission, an FFP configuration, and/or COT information associated with the WTRU. The QoS of the transmission, FFP configuration, and/or COT information associated with the WTRU may be indicated in one or more transmission(s) of the WTRU in the COT/FFP. The WTRU may (e.g., may then) determine whether to share the WTRU's COT/FFP based on one or more (e.g., any combination) of the following.

The WTRU may determine whether to allow another WTRU to share its COT/FFP based on a QoS (e.g., CAPC, priority) of the data. For example, the WTRU may be (pre)configured to share its COT/FFP with another WTRU if the priority of the data is smaller than a (pre)configured threshold; otherwise, the WTRU may not share its COT/FFP with the other WTRU.

The WTRU may determine whether to allow another WTRU to share its COT/FFP based on a QOS (e.g., CAPC, priority) of the data associated with the reserved COT/FFP. For example, the WTRU may be (pre)configured to share its COT/FFP with the other WTRU if the priority of the data associated with the reserved COT/FFP is larger than a (pre)configured threshold; otherwise, the WTRU may not share its COT/FFP with the other WTRU.

The WTRU may determine whether to allow another WTRU to share its COT/FFP based on a relative QoS between its data and data associated with the reserved COT/FFP. For example, the WTRU may be (pre)configured to share its COT/FFP with the other WTRU if the priority offset between its data and the data associated with the reserved COT/FFP is greater than a (pre)configured threshold; otherwise, the WTRU may not share its COT/FFP with the other WTRU.

The WTRU may determine whether to allow another WTRU to share its COT/FFP based on a location of the reserved COT/FFP. For example, the WTRU may rate-match/puncture a PSCCH/PSSCH at some time before the reserved COT/FFP. If the reserved COT/FFP location causes the WTRU to rate-match/puncture the PSCCH/PSSCH in a duration that is greater than a (pre)configured threshold, the WTRU may not allow the other WTRU to share the COT; otherwise, the WTRU may allow the other WTRU to share the COT/FFP.

The WTRU may determine whether to allow another WTRU to share its COT/FFP based on a reserved FFP. For example, the WTRU may share its COT/FFP with the other WTRU if the duration of the reserved COT/FFP within the COT/FFP of the WTRU is smaller than a (pre)configured threshold; otherwise, the WTRU may not share its COT/FFP with the other WTRU.

The WTRU may determine whether to allow another WTRU to share its COT/FFP based on a duration of its initiated COT/FFP. For example, the WTRU may share its COT/FFP with the other WTRU if the duration of its initiated COT/FFP within the COT/FFP of the WTRU is smaller than a (pre)configured threshold; otherwise, the WTRU may not share its COT/FFP with the other WTRU.

The WTRU may determine whether to allow another WTRU to share its COT/FFP based on reserved frequency resources. For example, the WTRU may share its COT/FFP with the other WTRU if the amount of the reserved frequency resources (e.g., number of reserved interlaces) is smaller than a (pre)configured threshold; otherwise, the WTRU may not share its COT/FFP with the other WTRU. As another example, the WTRU may share its COT/FFP with the other WTRU if the reserved frequency resource is different from its selected frequency resource; otherwise, the WTRU may not share its COT/FFP with the other WTRU.

The WTRU may determine whether to allow another WTRU to share its COT/FFP based on a buffer status of the WTRU. For example, the WTRU may share its COT/FFP with the other WTRU if the amount of data in its buffer (e.g., with a certain QoS) is smaller than a (pre)configured threshold; otherwise, the WTRU may not share its COT/FFP with the other WTRU.

The WTRU may determine whether to allow another WTRU to share its COT/FFP based on an amount of its frequency resource. For example, the WTRU may share its COT/FFP with the other WTRU if the required amount of its frequency resource (e.g., in each slot) is smaller than a (pre)configured threshold; otherwise, the WTRU may not share its COT/FFP with the other WTRU.

A WTRU may reselect frequency resources (e.g., interlace) for PSCCH/PSSCH transmission in its FFP.

If the WTRU allows another WTRU to share its COT/FFP, the WTRU may reselect another frequency resource (e.g., another set of interlaces) to avoid collision with the reserved frequency (e.g., interlace) of other WTRU sharing the COT/FFP. The WTRU may use the reselected resource to perform initial transmission of a new TB. The WTRU may continue to retransmit the TB in the reselected resource in subsequent slot(s).

A WTRU may determine whether to preempt its COT/FFP.

The WTRU may detect a reserved COT/FFP of another WTRU within its COT/FFP. The WTRU may determine whether to preempt its COT/FFP (e.g., by stopping the use of its COT/FFP) to yield the resource for the other WTRU. The WTRU may determine whether to preempt its COT/FFP based on one or more (e.g., any combination) of the following.

The WTRU may determine whether to preempt its COT/FFP based on a QoS (e.g., CAPC, priority) of the data. For example, the WTRU may preempt its COT/FFP if the priority of the data is smaller than a (pre)configured threshold; otherwise, the WTRU may not preempt its COT/FFP.

The WTRU may determine whether to preempt its COT/FFP based on a QoS (e.g., CAPC, priority) of the data associated with the reserved COT/FFP. For example, the WTRU may preempt its COT/FFP if the priority of the associated data of the reserved COT/FFP is larger than a (pre)configured threshold; otherwise, the WTRU may not preempt its COT/FFP.

The WTRU may determine whether to preempt its COT/FFP based on a relative QoS between its data and the reserved COT/FFP. For example, the WTRU may preempt its COT/FFP if the priority offset between the data of the WTRU and the associated data of the reserved COT/FFP is greater than a (pre)configured threshold; otherwise, the WTRU may not preempt its COT/FFP.

The WTRU may determine whether to preempt its COT/FFP based on a reserved COT/FFP. For example, the WTRU may preempt its COT/FFP if the reserved COT/FFP within its COT/FFP is larger than a (pre)configured threshold; otherwise, the WTRU may not preempt its COT/FFP.

The WTRU may determine whether to preempt its COT/FFP based on a duration of its initiated COT/FFP. For example, the WTRU may preempt its COT/FFP if the duration of its initiated COT/FFP is smaller than a (pre)configured threshold; otherwise, the WTRU may not preempt its COT/FFP.

The WTRU may determine whether to preempt its COT/FFP based on reserved frequency resources. For example, the WTRU may preempt its COT/FFP if the amount of the reserved frequency resources (e.g., number of reserved interlaces) is greater than a (pre)configured threshold; otherwise, the WTRU may not preempt its COT/FFP.

The WTRU may determine whether to preempt its COT/FFP based on an amount of its frequency resource(s). For example, the WTRU may preempt its COT/FFP if the amount its frequency resources used in each slot (e.g., number of reserved interlaces) is smaller than a (pre)configured threshold; otherwise, the WTRU may not preempt its COT/FFP.

The WTRU may determine whether to preempt its COT/FFP based on a buffer status of the WTRU. For example, the WTRU may preempt its COT/FFP if the amount of data in the buffer of the WTRU is smaller than a (pre)configured threshold; otherwise, the WTRU may not preempt its COT/FFP.

A WTRU may determine an FFP and/or HARQ occasion for which to request HARQ feedback from an Rx WTRU. For example, a TB may require HARQ feedback. A Tx WTRU may (e.g., determine to) request that the Rx WTRU feedback in the TX WTRU's FFP (e.g., for an indicated PSFCH occasion to feedback) or in the Rx WTRU's own initiated FFP, for example, based on one or more of the following: a QoS of the TB, the remaining transmissions of the WTRU in the period (e.g., to maintain the COT until the indicated PSFCH), the remaining COT duration, and/or the gap to the next FFP of the Rx WTRU(s). The WTRU may perform one or more (e.g., any combination) of the following: receive a PSFCH configuration in the resource pool (e.g., every slot); receive an FFP and/or PSFCH configuration from a peer WTRU (e.g., WTRU-B), for example, via PC5-RRC; acquire a COT in a (e.g., one) FFP; determine (e.g., for each transmission of a HARQ-enabled TB) the feedback occasion based on one or more of the following: the priority of the TB, the remaining number of the WTRU's transmission, the remaining COT duration, the gap to the next FFP of the Rx WTRU(s), and/or PSFCH configuration; determine the duration and/or the number of HARQ feedback attempts for the Rx WTRU based on the QoS of the TB and/or the FFP configuration of the WTRU; indicate the HARQ feedback occasion(s)/resource(s) in the SCI for a (e.g., each) transmission and/or the maximum number of feedback attempts; monitor the feedback for a (e.g., each) transmission; and/or access the channel and perform retransmission for the TB, for example, if NACK/DTX are detected in the maximum number of HARQ attempts.

An Rx WTRU may perform HARQ feedback. The WTRU (e.g., Rx WTRU) may receive a transmission from a Tx WTRU requiring feedback in the Rx WTRU's FFP in a (e.g., one) of N PSFCH occasions. The WTRU (e.g., Rx WTRU) may perform channel access (e.g., contiguously in each FFP) until successfully transmitting a (e.g., one) PSFCH out of N occasions. The WTRU (e.g., Rx WTRU) may perform one or more (e.g., any combination) of the following: determine an FFP configuration (e.g., period and/or offset), for example, based on the whether the configured service support HARQ feedback (e.g., the initial symbols of FFP may be used for PSFCH transmission, for example, if the service supports HARQ feedback, or the initial symbols of FFP may be used for PSCCH/PSSCH, for example, if the service does not support HARQ feedback); receive a transmission of the Tx WTRU, which may indicate performing HARQ feedback in the Rx WTRU's FFP and/or assessing a maximum N CCA occasions; perform (e.g., for each FFP, in the next N FFPs) a CCA to access the channel and transmit PSFCH in the PSFCH occasion until successfully transmitting PSFCH on a (e.g., one) occasion; and/or report channel access failure to gNB, for example, if the WTRU fails to access the channel in the occasions (e.g., all N occasions).

Although features and elements described above are described in particular combinations, each feature or element may be used alone without the other features and elements of the preferred embodiments, or in various combinations with or without other features and elements.

Although the implementations described herein may consider 3GPP specific protocols, it may be understood that the implementations described herein are not restricted to this scenario and may be applicable to other wireless systems. For example, although the solutions described herein consider LTE, LTE-A, New Radio (NR) or 5G specific protocols, it may be understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-20. (canceled)

21. A wireless transmit/receive unit (WTRU) comprising:
a processor configured to:
receive configuration information that indicates a mapping between a physical sidelink shared channel (PSSCH) and a first physical sidelink feedback channel (PSFCH) occasion, and between the PSSCH and a second PSFCH occasion, wherein the second PSFCH occasion is subsequent to the first PSFCH occasion;
receive the PSSCH, wherein the PSSCH has hybrid automatic repeat request (HARQ) feedback enabled;
based on the mapping between the PSSCH and the first PSFCH occasion, perform a first channel access procedure;
perform a second channel access procedure based on a failure by the WTRU to access a channel via the first channel access procedure; and
on a condition that the WTRU accesses the channel via the second channel access procedure, send a PSFCH transmission in the second PSFCH occasion.

22. The WTRU of claim 21, wherein the configuration information indicates a number of PSFCH occasions comprising the first PSFCH occasion and the second PSFCH occasion, and wherein, on a condition that the WTRU fails to access the channel via the second channel access procedure, the processor is further configured to:
determine, based on the configuration information, that the WTRU has failed to access the channel in each of the number of PSFCH occasions; and
based on the determination, send an indication to a network that the WTRU failed to access the channel.

23. The WTRU of claim 21, wherein the configuration information indicates a number of PSFCH occasions comprising the first PSFCH occasion and the second PSFCH occasion, and wherein, on a condition that the WTRU fails to access the channel via the second channel access procedure, the processor is further configured to:
determine, based on the configuration information, that the WTRU has failed to access the channel in each of the number of PSFCH occasions; and
based on the determination, cancel the PSFCH transmission.

24. The WTRU of claim 21, wherein the configuration information indicates a mapping between the PSSCH and a third PSFCH occasion, wherein the third PSFCH occasion is subsequent to the second PSFCH occasion, and wherein, on a condition that the WTRU fails to access the channel via the second channel access procedure, the processor is further configured to:
perform a third channel access procedure; and
on a condition that the WTRU accesses the channel via the third channel access procedure, send a PSFCH transmission in the third PSFCH occasion.

25. The WTRU of claim 21, wherein the configuration information indicates a maximum HARQ feedback latency, and wherein, on a condition that the WTRU fails to access the channel via the second channel access procedure, the processor is further configured to:
determine that the maximum HARQ feedback latency has been reached; and
based on the determination, send an indication to a network that the WTRU failed to access the channel.

26. The WTRU of claim 21, wherein the configuration information indicates a first set of resource elements and a second set of resource elements, the first set of resource elements comprises common resource elements, and the second set of resource elements is associated with sending HARQ acknowledgement (ACK)/no acknowledgement (NACK) feedback associated with the PSSCH.

27. The WTRU of claim 26, wherein the configuration information further indicates a mapping between PSSCHs and PSFCH resources in the second set of resource elements, and the processor is further configured to determine to send the HARQ ACK/NACK feedback in a PSFCH resource in the second set of resources based on a location of the PSSCH and the mapping between the PSSCHs and PSFCH resources.

28. The WTRU of claim 26, wherein the processor is further configured to determine to send the PSFCH transmission in a PSFCH resource in the second set of resources based on one or more of:
an interlace index of the PSSCH;
a slot index of the PSSCH;
a number of slots associated with the PSFCH resource;
a number of resource elements, in the second set of resource elements, configured in a PSFCH slot;
a source identifier (ID) of the PSSCH;
a destination ID of the PSSCH;
a cast type of a transport block associated with the PSSCH; or
a member ID and a number of members in a groupcast group.

29. The WTRU of any one of claims 26-28, wherein the first set of resource elements is associated with satisfying an occupied channel bandwidth (OCB) condition, and the processor is further configured to send an index of a common interlace in the first set of resource elements.

30. A method, performed by a wireless transmit/receive unit (WTRU), the method comprising:
receiving configuration information that indicates a mapping between a physical sidelink shared channel (PSSCH) and a first physical sidelink feedback channel (PSFCH) occasion, and between the PSSCH and a second PSFCH occasion, wherein the second PSFCH occasion is subsequent to the first PSFCH occasion;
receiving the PSSCH, wherein the PSSCH has hybrid automatic repeat request (HARQ) feedback enabled;
based on the mapping between the PSSCH and the first PSFCH occasion, performing a first channel access procedure;
performing a second channel access procedure based on a failure by the WTRU to access a channel via the first channel access procedure; and
on a condition that the WTRU accesses the channel via the second channel access procedure, sending a PSFCH transmission in the second PSFCH occasion.

31. The method of claim 30, wherein the configuration information indicates a number of PSFCH occasions comprising the first PSFCH occasion and the second PSFCH occasion, and wherein, on a condition that the WTRU fails to access the channel via the second channel access procedure, the method further comprises:
determining, based on the configuration information, that the WTRU has failed to access the channel in each of the number of PSFCH occasions; and
based on the determination, sending an indication to a network that the WTRU failed to access the channel.

32. The method of claim 30, wherein the configuration information indicates a number of PSFCH occasions comprising the first PSFCH occasion and the second PSFCH occasion, and wherein, on a condition that the WTRU fails to access the channel via the second channel access procedure, the method further comprises:
determining, based on the configuration information, that the WTRU has failed to access the channel in each of the number of PSFCH occasions; and
based on the determination, canceling the PSFCH transmission.

33. The method of claim 30, wherein the configuration information indicates a mapping between the PSSCH and a third PSFCH occasion, wherein the third PSFCH occasion is subsequent to the second PSFCH occasion, and wherein, on a condition that the WTRU fails to access the channel via the second channel access procedure, the method further comprises:
performing a third channel access procedure; and
on a condition that the WTRU accesses the channel via the third channel access procedure, sending a PSFCH transmission in the third PSFCH occasion.

34. The method of claim 30, wherein the configuration information indicates a maximum HARQ feedback latency, and wherein, on a condition that the WTRU fails to access the channel via the second channel access procedure, the method further comprises:
determining that the maximum HARQ feedback latency has been reached; and
based on the determination, sending an indication to a network that the WTRU failed to access the channel.

35. The method of claim 30, wherein the configuration information indicates a first set of resource elements and a second set of resource elements, the first set of resource elements comprises common resource elements, and the second set of resource elements is associated with sending HARQ acknowledgement (ACK)/no acknowledgement (NACK) feedback associated with the PSSCH.

36. The method of claim 35, wherein the configuration information further indicates a mapping between PSSCHs and PSFCH resources in the second set of resource elements, and the method further comprises determining to send the HARQ ACK/NACK feedback in a PSFCH resource in the second set of resources based on a location of the PSSCH and the mapping between the PSSCHs and PSFCH resources.

37. The method of claim 35, wherein the method further comprises determining to send the PSFCH transmission in a PSFCH resource in the second set of resources based on one or more of:
an interlace index of the PSSCH;
a slot index of the PSSCH;
a number of slots associated with the PSFCH resource;
a number of resource elements, in the second set of resource elements, configured in a PSFCH slot;
a source identifier (ID) of the PSSCH;
a destination ID of the PSSCH;
a cast type of a transport block associated with the PSSCH; or
a member ID and a number of members in a groupcast group.

38. The method of claim 35, wherein the first set of resource elements is associated with satisfying an occupied channel bandwidth (OCB) condition, and the method further comprises sending an index of a common interlace in the first set of resource elements.
